(19) United States
(12) Patent Application Publication
(10) Pub. No.: US 2020/0014664 A1
(43) Pub. Date: Jan. 9, 2020

(54) Shadow Protocol Enabling Communications Through Remote Account Login

(71) Applicant: Averon US, Inc., Henderson, NV (US)

(72) Inventors: Wendell BROWN, Henderson, NV (US); Mark HERSCHBERG, Henderson, NV (US)

(21) Appl. No.: 16/504,927

(22) Filed: Jul. 8, 2019

Related U.S. Application Data
(60) Provisional application No. 62/694,517, filed on Jul. 6, 2018.

(51) Int. Cl. H04L 29/06; H04L 9/06; G06F 16/182; H04L 29/12

(52) U.S. Cl. CPC H04L 63/0421; H04L 61/20; G06F 16/182; H04L 9/0637

(57) ABSTRACT

Embodiments of the present disclosure provide apparatuses, systems, methods, and computer program products for creating, managing, and utilizing shadow addresses. Shadow addresses may be generated based on a based address element associated with a client device, and an address construction element set received from the client device. The base address element may be authenticated as associated with the client device to confirm the user's identity, for example through a header enrichment process or other verification process. Shadow addresses may be used to transmit and receive communications for various purposes, including messaging, service login, and facilitating transactions. An example apparatus may be provided, the apparatus configured to receive, from a client device, an address construction element set; identify a base address element associated with the client device; and generate a shadow address by applying the base address element and the address construction element set to a one-way transformation function.

### CROSS-REFERENCE TO RELATED APPLICATIONS

This application claims priority to U.S. provisional Application No. 62/694,517 filed Jul. 6, 2018, the content of which is incorporated herein by reference in its entirety.

### TECHNOLOGICAL FIELD

Embodiments of the present disclosure relate, generally, to managing shadow addresses associated with a base address element that can be authenticated to confirm a user identity, and more specifically, to creation and management of shadow addresses and use of created shadow addresses, for example for login verification and communication.

### BACKGROUND

Communication addresses and identifiers (e.g., telephone numbers, email addresses, and the like) uniquely identify a user to enable communication between that user and other users via electronic devices, such as mobile devices. Such information generally remains constant, such that any and all users may contact another user, and with do so in a consistent manner, if their communication address or identifier is known by each other user. Applicant has discovered problems with current systems, methods, apparatuses, and computer program products that manage and use communication addresses and identifiers for purposes such as inter-user communications. Through applied effort, ingenuity, and innovation, Applicant has solved many of these identified problems by developing solutions provided in embodiments of the present disclosure, which are described in detail below.

### BRIEF SUMMARY

In general, embodiments of the present disclosure provided herein include systems, methods, apparatuses, and computer readable media for improved communication management via shadow addresses. Other systems, apparatuses, methods, computer readable media, and features thereof will become apparent to one with skill in the art upon examination of the following figures and detailed description. It is intended that all such additional systems, apparatuses, methods, computer readable media, and features included within this description be within the scope of the disclosure, and be protected by the following claims.

In general, embodiments of the present disclosure provided herein include systems, methods, apparatuses, and computer program products. In this regard, embodiment apparatus(es) and/or system(s) may include computer-coded instructions capable of similar operations to those performed in embodiment methods. Similarly, embodiment computer program products may include program code instructions for similar operations to those performed in embodiment methods.

In some example embodiments, an apparatus for managing communications via shadow addresses is provided. The apparatus includes at least one processor and at least one memory, the at least one memory having computer-coded instructions therein. The computer-coded instructions are configured to cause the apparatus to receive, from a client device, an address construction element set. The computer-coded instructions are further configured to cause the apparatus to identify a base address element associated with the client device. The computer-coded instructions are further configured to cause the apparatus to generate a shadow address based on the base address element and the address construction element set, where in particular embodiments, to generate the shadow address the apparatus is configured to apply the base address element and the address construction element set to at least one one-way transformation function.

In some such example embodiments, to identify the base address element associated with the client device, the computer-coded instructions are further configured to identify the base address element using a header enrichment process performed via a carrier network. In some embodiments, the apparatus is further configured to authenticate the base address element using an authentication process to confirm the identity of the user associated with the client device. In some embodiments, the authentication process is a header enrichment process, OAuth process, or login process.

In some such example embodiments, the apparatus is further configured to receive, from a communication transmitting client device, at least one communication transmission signals, the at least one communication transmission signals associated with at least one communication associated with the shadow address, and store the at least one communication associated with the shadow address. Further still, in some such embodiments, to store the at least one communication associated with the shadow address, the apparatus is configured to store at least a portion of the at least one communication to a communication storage blockchain based on the shadow address.

In some such example embodiments, where the client device comprises a first client device, the apparatus is further configured to receive, from a retrieving client device, a communication retrieval request associated with the base address element and the address construction element set. Further, in some such embodiments, the apparatus is configured to authenticate the base address element to confirm the identity of the user associated with the retrieving client device. Further, in some such embodiments, the apparatus is further configured to generate the shadow address based on the base address element and the address construction element set. Further, in some such embodiments, the apparatus is further configured to retrieve a communications set based on the shadow address, the communications set comprising the at least one communication associated with the shadow address. Further, in some such embodiments, the apparatus is further configured to transmit the communications set to the retrieving client device. In some such embodiments, the first client device and the retrieving client device are the same. In other embodiments, the retrieving client device is a second client device associated with the same user as the first client device, but not the same device.

In some such example embodiments, to receive the address construction elements set, the apparatus is configured to receive, from the client device, a shadow address generation request comprising the address construction element set and the base address element, and to identify the base address element, the apparatus is configured to parse the shadow address generation request to extract the base address element.

In some such example embodiments, the apparatus is further configured to receive, from a service accessing client device, a service shadow login request comprising at least the base address element and the address construction elements. In some such embodiments, the apparatus is further configured to authenticate the base address element to confirm the identity of the user associated with the service accessing client device. In some such embodiments, the apparatus is further configured to generate the shadow address based on the base address element the address construction element set. In some such embodiments, the apparatus is further configured to provide, to the service accessing client device, a service shadow access information associated with the shadow address, the service shadow access information configured to enable access to a service.

In other example embodiments, a computer-implemented method for managing communications via shadow addresses is provided. The method comprises receiving, from a client device, an address construction element set. The method further comprises identifying a base address element associated with the client device. The method further comprises generating a shadow address based on the base address element and the address construction element set, where in particular embodiments, generating the shadow address comprises applying the base address element and the address construction element set to at least one one-way transformation function.

In some such example embodiments, identifying the base address element associated with the client device comprises identifying the base address element using a header enrichment process performed via a carrier network. In some embodiments, method further comprises authenticating the base address element using an authentication process to confirm the identity of the user associated with the client device. In some embodiments, the authentication process is a header enrichment process, OAuth process, or login process.

In some such example embodiments, the method further comprises receiving, from a communication transmitting client device, at least one communication transmission signals, the at least one communication transmission signals associated with at least one communication associated with the shadow address, and storing the at least one communication associated with the shadow address. Further still, in some such embodiments, storing the at least one communication associated with the shadow address comprises storing at least a portion of the at least one communication to a communication storage blockchain based on the shadow address.

In some such example embodiments, where the client device comprises a first client device, the method further comprises receiving, from a retrieving client device, a communication retrieval request associated with the base address element and the address construction element set. Further, in some such embodiments, the method further comprises authenticating the base address element to confirm the identity of the user associated with the retrieving client device. Further, in some such embodiments method further comprises generating the shadow address based on the base address element and the address construction element set. Further, in some such embodiments, the method further comprises retrieving a communications set based on the shadow address, the communications set comprising the at least one communication associated with the shadow address. Further, in some such embodiments, the method further comprises transmitting the communications set to the retrieving client device. In some such embodiments, the first client device and the retrieving client device are the same. In other embodiments, the retrieving client device is a second client device associated with the same user as the first client device, but not the same device.

In some such example embodiments, receiving the address construction elements set comprises receiving, from the client device, a shadow address generation request comprising the address construction element set and the base address element, and identifying the base address element comprises parsing the shadow address generation request to extract the base address element.

In some such example embodiments, the method further comprises receiving, from a service accessing client device, a service shadow login request comprising at least the base address element and the address construction elements. In some such embodiments, the method further comprises authenticating the base address element to confirm the identity of the user associated with the service accessing client device. In some such embodiments, the method further comprises generating the shadow address based on the base address element the address construction element set. In some such embodiments, the method further comprises providing, to the service accessing client device, a service shadow access information associated with the shadow address, the service shadow access information configured to enable access to a service.

In yet other example embodiments, a computer program product for managing communications via shadow addresses is provided. The computer program product comprises one or more non-transitory computer readably storage medium comprising computer program instructions. The computer program instructions are configured for, when executed by a processor, receiving, from a client device, an address construction element set. The computer program instructions are further configured for identifying a base address element associated with the client device. The computer program instructions are further configured for generating a shadow address based on the base address element and the address construction element set, where in particular embodiments, generating the shadow address comprises applying the base address element and the address construction element set to at least one one-way transformation function.

In some such example embodiments, the computer program instructions are configured for identifying the base address element associated with the client device comprises identifying the base address element using a header enrichment process performed via a carrier network. In some embodiments, the computer program instructions are further configured for authenticating the base address element using an authentication process to confirm the identity of the user associated with the client device. In some embodiments, the authentication process is a header enrichment process, OAuth process, or login process.

In some such example embodiments, the computer program instructions are further configured for receiving, from a communication transmitting client device, at least one communication transmission signals, the at least one communication transmission signals associated with at least one communication associated with the shadow address, and storing the at least one communication associated with the shadow address. Further still, in some such embodiments, the computer program instructions are further configured for storing the at least one communication associated with the shadow address comprises storing at least a portion of the at least one communication to a communication storage blockchain based on the shadow address.

In some such example embodiments, where the client device comprises a first client device, the computer program instructions are further configured for receiving, from a retrieving client device, a communication retrieval request associated with the base address element and the address construction element set. Further, in some such embodiments, the computer program instructions are further configured for authenticating the base address element to confirm the identity of the user associated with the retrieving client device. Further, in some such embodiments, the computer program instructions are further configured for generating the shadow address based on the base address element and the address construction element set. Further, in some such embodiments, the computer program instructions are further configured for retrieving a communications set based on the shadow address, the communications set comprising the at least one communication associated with the shadow address. Further, in some such embodiments, the computer program instructions are further configured for transmitting the communications set to the retrieving client device. In some such embodiments, the first client device and the retrieving client device are the same. In other embodiments, the retrieving client device is a second client device associated with the same user as the first client device, but not the same device.

In some such example embodiments, receiving the address construction elements set comprises receiving, from the client device, a shadow address generation request comprising the address construction element set and the base address element, and identifying the base address element comprises parsing the shadow address generation request to extract the base address element.

In some such example embodiments, the computer program instructions are further configured for receiving, from a service accessing client device, a service shadow login request comprising at least the base address element and the address construction elements. In some such embodiments, the computer program instructions are further configured for authenticating the base address element to confirm the identity of the user associated with the service accessing client device. In some such embodiments, the computer program instructions are further configured for generating the shadow address based on the base address element the address construction element set. In some such embodiments, the computer program instructions are further configured for providing, to the service accessing client device, a service shadow access information associated with the shadow address, the service shadow access information configured to enable access to a service.

In some such example apparatus, method, and/or computer program product embodiments, each communication includes a recipient shadow address field. Further, in some example apparatus, method, and/or computer program product embodiments, each communication of the retrieved communications set comprises the shadow address in a recipient shadow address field.

In some such example apparatus, method, and/or computer program product embodiments, the shadow address is associated with a shadow address restriction settings set. Further, in some such embodiments, the shadow address restriction settings set comprises a verified sender shadow address set. Alternatively or additionally, in some such example apparatus, method, and/or computer program product embodiments, the shadow address restrictions setting set comprises a communication permissions set.

In some such example apparatus, method, and/or computer program product embodiments, the base address element represents various address types via an electronic-variable types. In some such example apparatus, method, and/or computer program product embodiments, the base address element comprises an electronic representation of a telephone number or an electronic representation of an email address.

In other embodiments, another apparatus is provided for. The apparatus comprises computer-coded instructions configured to cause the apparatus to store a unique user identifier associated with a user entity; receive a first user input indicative of a request to generate a shadow address associated with the unique user identifier; transmit a shadow address creation request to a shadow management system, the shadow address creation request comprising an address construction element set comprising at least the unique user identifier; and receive, from the shadow management system in response to the shadow address creation request, a shadow address associated with the address construction element set and a base address element associated with the apparatus.

In some such embodiments, the apparatus is configured to transmit the shadow address creation request to the shadow management system via a carrier network configured to inject the base address element, via a header enrichment process, into the shadow address creation request.

In some such embodiments, the apparatus is further configured to receive, from an authentication server, authentication information comprising the base address element signed by a signing authority associated with the authentication server, wherein the shadow address creation request further comprises the authentication information.

In some such embodiments, the apparatus is further configured to receive, via a second user input, identifying information associated with the unique user identifier; and store the identifying information associated with the unique user identifier, wherein the shadow address creation request further comprises the identifying information.

In some such embodiments, the apparatus is further configured to provide the shadow address to a second client device associated with the unique user identifier. In some such embodiments, the apparatus is further configured to store the shadow address associated with the unique user identifier. In some such embodiments, the apparatus is further configured to render, to an interface, a representation of the shadow address, wherein the representation of the shadow address comprises a human-readable text representation of the shadow address, a binary representation of the shadow address, or a scannable representation of the shadow address.

In other embodiments, another computer-implemented method is provided for. The method comprises storing a unique user identifier associated with a user entity; receiving a first user input indicative of a request to generate a shadow address associated with the unique user identifier; transmitting a shadow address creation request to a shadow management system, the shadow address creation request comprising an address construction element set comprising at least the unique user identifier; and receiving, from the shadow management system in response to the shadow address creation request, a shadow address associated with the address construction element set and a base address element associated with the apparatus.

In some such embodiments of the method, transmitting the shadow address creation request further comprises transmitting the shadow address creation request to the shadow management system via a carrier network configured to inject the base address element, via a header enrichment process, into the shadow address creation request.

In some such embodiments of the method, the method further comprises receiving, from an authentication server, authentication information comprising the base address element signed by a signing authority associated with the authentication server, wherein the shadow address creation request further comprises the authentication information.

In some such embodiments of the method, the method further comprises receiving, via a second user input, identifying information associated with the unique user identifier; and storing the identifying information associated with the unique user identifier, wherein the shadow address creation request further comprises the identifying information.

In some such embodiments of the method, the method further comprises providing the shadow address to a second client device associated with the unique user identifier. In some such embodiments of the method, the method further comprises storing the shadow address associated with the unique user identifier. In some such embodiments of the method, the method further comprises rendering, to an interface, a representation of the shadow address, wherein the representation of the shadow address comprises a human-readable text representation of the shadow address, a binary representation of the shadow address, or a scannable representation of the shadow address.

In other embodiments, another computer program product is provided for. The computer program product comprises computer program instructions for storing a unique user identifier associated with a user entity; receiving a first user input indicative of a request to generate a shadow address associated with the unique user identifier; transmitting a shadow address creation request to a shadow management system, the shadow address creation request comprising an address construction element set comprising at least the unique user identifier; and receiving, from the shadow management system in response to the shadow address creation request, a shadow address associated with the address construction element set and a base address element associated with the apparatus.

In some example embodiments of the computer program product, transmitting the shadow address creation request further comprises transmitting the shadow address creation request to the shadow management system via a carrier network configured to inject the base address element, via a header enrichment process, into the shadow address creation request.

In some example embodiments of the computer program product, the computer program instructions are further configured for receiving, from an authentication server, authentication information comprising the base address element signed by a signing authority associated with the authentication server, wherein the shadow address creation request further comprises the authentication information.

In some example embodiments of the computer program product, the computer program instructions are further configured for receiving, via a second user input, identifying information associated with the unique user identifier; and storing the identifying information associated with the unique user identifier, wherein the shadow address creation request further comprises the identifying information.

In some example embodiments of the computer program product, the computer program instructions are further configured for providing the shadow address to a second client device associated with the unique user identifier. In some example embodiments of the computer program product, the computer program instructions are further configured for storing the shadow address associated with the unique user identifier. In some example embodiments of the computer program product, the computer program instructions are further configured for rendering, to an interface, a representation of the shadow address, wherein the representation of the shadow address comprises a human-readable text representation of the shadow address, a binary representation of the shadow address, or a scannable representation of the shadow address.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specifically configured within embodiments of the present disclosure may operate;

FIG. 2 illustrates a block diagram of an example apparatus that may be specially configured in accordance with an example embodiment of the present disclosure;

FIG. 3 illustrates a block diagram of an example apparatus that may be specially configured in accordance with an example embodiment of the present disclosure;

FIG. 4 illustrates a data flow diagram of an example set of steps in an example system in accordance with an example embodiment of the present disclosure;

FIG. 5 illustrates a flowchart depicting various operations performed in an example process for generating a shadow address, for example as a part of an example process for managing and utilizing a shadow address, in accordance with an example embodiment of the present disclosure;

FIG. 6 illustrates a flowchart depicting various operations performed in an example process for transmitting and receiving communications utilizing a shadow address, for example as a part of an example process for managing and utilizing a shadow address, in accordance with an example embodiment of the present disclosure;

FIG. 7 illustrates a flowchart depicting various operations performed in an example process for logging into a service associated with a shadow address, for example as a part of an example process for managing and utilizing a shadow address, in accordance with an example embodiment of the present disclosure; and

FIG. 8 illustrates a flowchart depicting various operations performed in an example process for creating a shadow address based on at least stored information, and optionally managing and/or using the shadow address, in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein. Rather, these embodiments are provided so that this disclosure will satisfy applicable legal requirements. Like numbers refer to like elements throughout.

### Overview

Systems are often configured to enable messaging between users accessing the system via particular addresses, such that a user may receive messages associated with the address. The address may uniquely identify the particular user account associated with a particular user of a particular platform, format (e.g., email, text messaging, chat, and the like), and/or service. For example, a cell phone number or an email addresses provide a unique address that identifies a particular user account for a corresponding service (e.g., a telephone service and an email service, respectively).

Each address can be disseminated to another user for use in direct correspondence between the two users, via corresponding addresses. For example, each user may access a client device to utilize their address to communicate with the other user, for example by accessing cell phones and/or personal computers, or the like. In a particular example, a text message communication may be transmitted between users associated with addresses embodied by their cell phone numbers, or an email communication may be transmitted between users associated with particular email addresses.

Each user generally can manage only a limited number of addresses. For example, each user is generally associated with only a single cell phone number, or a limited number of cell phone numbers (e.g., a personal cell phone number and a work cell phone number). Similarly, for example, each user is generally associated with only one or a small number of email addresses (for example, less than 5, or otherwise a fixed number), which each may be used for a myriad of purposes. Even if a user has more than one address by which they can be reached (e.g., two cell phone numbers and five email addresses), a user cannot manage the addresses required to correspond to a number of relationships to other users or other addresses with which a particular user communicates. For example, a user would not be able to manage utilizing a single address for each third-party address with which the user communicates.

In this regard, the number of addresses associated with, or managed by, a particular user may be represented by an O(1) relationship. In other words, a user is capable of managing only a small fixed number of addresses as compared to an O(N) relationship that represents the number of other addresses with which the user may communicate. For example, with only a few addresses, a particular user may communicate with a significant number of friends, for example where a number of friends is two to three orders of magnitude greater. With limited capacity to manage a growing number of addresses, a user cannot utilize an address (or a few addresses) to communicate in a one-to-one correspondence with the number of relationships, personas, or connections associated with the address. The user may attempt to categorize third-party addresses (e.g., phone numbers and email addresses with which the user communicates via one or more of the user's own address), but often the user will eventually be required to overload a particular category of the address by pigeonholing a classification as the number of connected third-party addresses grows in accordance with the pigeonhole principle. If a user attempts to solve this problem by creating additional addresses, the user may eventually not be able to manage the additional addresses required to provide a manageable, effective, and/or efficient solution. Additionally, if a user then wishes to disassociate relationships between one of their addresses and another user, the user may not be able to do so without affecting the ability of another user to communicate via the address.

A particular example of this problem arises in the context of a user using a single personal address for communicating in various personal relationships. User Alice may provide an address, for example, a cell phone number, to users Bob, Carol, and Dave. Bob, Carol, and Dave may communicate with Alice via each of their own addresses (e.g., their corresponding phone numbers) utilizing a client device associated with each user (e.g., a mobile phone). Each user, for example, may use their own mobile phone number to communicate with Alice via text messaging. It should be appreciated that other communication formats may similarly be utilized in other examples (e.g., email using email addresses, chat messaging using chat identifier, or the like, instead of phone numbers).

Alice may decide, for any of a variety of reasons, she no longer wants to receive communications from Dave, but Dave may continue to communicate with Alice regardless. Alice cannot delete, disconnect, or otherwise disassociate the address Dave is using to contact her without affecting her connection with the other users, namely Bob and Carol, who would then be unable to communicate with Alice if she deleted, disconnected, or disassociated the address. Dependent on the service utilized to communicate, Alice may have the option to block communications from Dave's address, however such functionality is not guaranteed. Even if such functionality is provided, this option is not effective nor efficient as the social network graph between Alice and others grows to include connections of hundreds, thousands, or more addresses. Similarly, even if Alice successfully blocks Dave's address (e.g., blocking text messages from his phone number), Dave may obtain a new address (e.g., a second phone number) and continue to contact Alice at her same address. Given the limited resources and technological implementations to block or otherwise avoid communication from specific addresses associated with traditional communication systems and services, this problem may continue indefinitely. In the case of other types of addresses, for example email addresses, this problem may be further exacerbated by the ease of creating a new address. For example, for some communication formats, a negligible time cost and/or monetary cost may be required to create a new address.

Communication via a single address or small number of addresses further suffers from problems associated with communication prioritization. For example, returning to the example of user Alice, Alice may utilize a particular email for professional communications. However, within the category of professional communications, Alice may provide the email address to co-workers, customers, and partners, and also provide the same email address to users generally via her business card and at conferences, for example at the end of a presentation. Given the scope and publicity of the dissemination methods, the group of users that communicate with Alice from a business card or conference may include tens, hundreds, or thousands of users.

Alice may desire to prioritize communications from senders associated with the groups of co-workers, customers, and partners, and not prioritize communications from senders associated with conferences or business cards. Alice may utilize some filter tools offered by a communication service to designate specific, known users into groups. However, such filter tools remain insufficient because Alice cannot know a priori how to group a previously unseen sender. The service managing Alice's address cannot automatically identify which of the above groups an unknown sender address falls into for purposes of categorization and prioritization. In this regard, communications from such senders cannot be adequately prioritized using a single address alone.

Another example context where use of addresses alone is insufficient arises in a circumstance where temporary access to an address is to be granted and revoked after a defined time interval. For example, an example scenario is where a fan wins a contest to communicate with a celebrity for a predetermined length of time. In such a circumstance, if the fan is given an address utilized by the celebrity, such as their phone number, the celebrity would not be able to avoid further communications from the fan after the predetermined length of time, especially in view of the deficiencies discussed above with respect to blocking an address associated with the fan. The celebrity would be forced to change their address to avoid such communications, which would affect the ability of other users to communicate with the celebrity as they would not have access to the new address.

Yet another context where use of addresses alone is insufficient is in communications between a user and an untrustworthy business. A user may wish to contact an address associated with a business for various purposes, for example to request coupons or to obtain customer support. However, a user may similarly desire the ability to end the relationship with the business. For example, the user may wish to avoid spam, unwanted solicitation, or because they do not trust the business to manage their contact information (e.g., where the business may constantly attempt to communicate with the user). If the user communicates with the business via an address, the user may not be able to terminate the relationship with the business without affecting the ability of other users to communicate via the address.

Temporary communications are similarly desirable in a context where a user wants to organize into sub-groups of people that the user is not going to communicate with after a certain time period. For example, a user may communicate with a sub-group during an event, such as a tailgate, concert, conference, or the like. The user may communicate with a particular sub-group of fellow event-goers, but wish to sever communications with the users after the event ends. If a user distributes their address associated with their user device, such as a mobile phone number for example, the user may not be able to disassociate the address without affecting other users that communicate via the address. For example, if the address is the user's main mobile phone number, all other users that communicate via the main phone number may be unable to communicate with the user as they will not know any address to utilize for such communications.

Use of such addresses may be further deficient in regard to operating anonymously. For example, in an example context, a user may desire to utilize an address for making a purchase anonymously. While cash may be used in person, cash cannot be used for electronic purchases. Cryptocurrency and/or electronic money orders may be utilized, but such solutions are complex to operate and/or unnecessarily add friction to the process. As addresses may be generally remain unchanged and associated with the user, as is often the case, such an address may be utilized to deanonymize the user.

Each of the above problems are associated in some manner with the central and generally unchangeable nature of an address. The generally unchanging, difficult to change, and/or undesirable to change address associated with a user represents a base address that serves as a binary link to the user, such that it is either active and all other users can communicate via the base address, or it is deactivated and no users can communicate via the base address. Individual connections to specific addresses or group of addresses cannot easily be maintained, especially when an address is publicized for communication by a large group of senders and communications are received from unknown addresses. Even when costs to create a new address are low, a user cannot manage the required number of addresses to communicate individually with a large group of senders, and the user may not desire to spend any time creating such accounts. In this regard, the user may not easily disassociate or change associations of an address without affecting the ability for other users who communicate via that address to do so, making disconnecting from individual sender address(es) difficult if not impossible. Additionally, sender prioritization cannot be performed for unknown senders, and filtering or prioritization a posteriori may be insufficient.

Embodiments of the present disclosure manage shadow addresses associated with a base address, for example by creating and configuring shadow addresses associated with a base address of a user. The shadow addresses (instead of the base address) may be utilized, for example for user communication, or various commands such as service login. An address associated with a user, such as a generally unchanging traditional address, may embody a base address. The base address may be represented by a base address element that embodies a particular machine-readable representation of the base address, for example a string or other variable-encoding format. A base address element may be used in combination with one or more address construction element(s) to generate a corresponding shadow address, where the shadow address is linked to the base address via the address construction element(s). For example, a combination of the base address element and the address construction elements may be transformed, for example using one or more hash functions and/or one or more iterations of such hash functions, to generate the shadow address. In other embodiments, the shadow address may be generated using another one-way function, algorithm, or mathematical transformation, or a combination thereof

In some embodiments, a client device is specially programmed, for example via one or more software applications executed on the client device, to enable access to a shadow address using a base address element and address construction element set. A shadow address may be accessed to edit configuration settings associated with the shadow address, transmit one or more communications to other users, transmit one or more command communications, and/or retrieve communications, via a shadow management system. In some embodiments, a client device is specially programmed to provide input components that enable a user to provide a base address element and/or address construction element set, for example via user engagement with an interface rendered to the client device. Additionally or alternatively, in some embodiments, a client device may automatically identify and/or retrieve a base address element and/or address construction element set, via hardware, software, or a combination thereof.

The additional address construction elements may embody identifiers, identifying information, descriptions, or other device, user, or service information, input and/or stored associated with a particular address, service, or the like. For example, the address construction elements may include identifying information stored via a client device, such as via software (e.g., contacts management software such as address book software) executed on the client device. The identifying information may be retrieved, generated, or otherwise utilized automatically to generate a shadow address that may be distributed and/or otherwise utilized. For example, the address construction element set, or a portion thereof, may be automatically parsed and/or extracted by a client device and utilized to generate a shadow address that may be provided and/or shared to other users for communicating using the generated shadow address. The client device may store the base address element and/or address construction element set such that it may be easily selected by the user for regenerating at a future time to access the address and retrieve communications or transmit new communications using the shadow address. In other embodiments, a user may manually input one or more address construction element(s) that the user tracks without automatic storage and/or retrieval by the client device.

In this regard, multiple shadow addresses may be easily and/or automatically generated associated with a particular base address without requiring management and/or creation effort by the user. For example, as a user inputs new identifying information for contacts (including a corresponding address to communicate with that contact) into contacts management software, a shadow address may be generated automatically associated with each entered contact such that the user may transmit communications to the contact via the associated created shadow address. In a circumstance where a user desires to stop receiving communications from the address associated with the contact, the user may simply delete the contact, indicate they do not desire to receive communications from the address, or otherwise delete an association with the shadow address used to communicate with the address. The third-party user then has no way to communicate with the user, as they do not have an address that remains associated with, or actively monitored by, the user associated with the now disassociated shadow address.

Each shadow address may be generated using a shadow address generation process that creates a unique shadow address based on a unique combination of the base address element and the additional account construction elements. The shadow address may be represented by a unique string generated based on the combination, which serves as a unique identifier to which communications may be sent. The shadow address may be provided to the associated user via a client device for dissemination and/or utilization. For example, the shadow address may be included in the form of a string, binary number, QR code, or other human-readable or encoded representations, which may be shareable electronically or via offline communications.

Embodiments may be configured to verify, or otherwise authenticate, the base address element through one or more verification processes, for example a DAA process such as a header enrichment process. The address construction elements may be provided as a set input by the user or automatically determined and transmitted by a client device, or software executed thereon. For example, the account construction elements may be parsed and/or extracted from contact details created and stored on the client device by the user. In some embodiments, a shadow address may be automatically generated using a portion of the contact details. In this regard, all elements used to generate a shadow address may be automatically retrieved without additional effort by the user to generate the address. Additionally, in some such embodiments, shadow addresses are highly secure in that they are generated based on the base address element retrieved, received, or otherwise identified using a highly secure process that confirms the identity of the user device. Given the ubiquity of user devices, for example mobile devices generally kept within a particular user's possession or immediate control and protected by passcode(s), biometric scan(s), or the like, the highly secure process of identifying the base address element further serves as a proxy for identifying the user associated with the client device.

Communications may be transmitted from a base address or shadow address to another shadow address, where the communication indicates a recipient shadow address. Embodiments store received communications such that they are retrievable by the recipient shadow addresses. Communications may be stored for a particular predetermined amount of time. Based on the verifiability of the base address element, the shadow address may only be reconstructed after having confirmed the base address element. For example, a base address element may be confirmed through a Direct Autonomous Authentication process, such as a header enrichment process, to confirm its veracity before utilizing it to generate a shadow address.

A user may utilize shadow addresses for various purposes. For example, shadow addresses may be generated for new groups, events, individual recipients, or other circumstances. Use of shadow addresses enables quick and/or automatic association of shadow addresses with said groups, events, individual recipients, or other circumstances. Similarly, use of shadow addresses enables quick and/or automatic disassociation with the shadow address from the corresponding base address, for example to prevent receiving communications in a circumstance where the user no longer desires to do so, without compromising the connection with other addresses. For example, in the Alice examples above, a shadow address may be automatically generated for each of the contacts Bob, Carol, and David, based on one or more identifiers or other information input by Alice and stored associated with each user. Alice may disassociate or otherwise disconnect the shadow address associated with David to entirely avoid receiving communications from him. Such communications may become irretrievable, deleted, or indicated as ignored, for example by deleting the association manually or automatically when the contact associated with Dave is deleted or when the contact is blocked, for example via contacts management software. Similarly, returning to the conference example, a shadow address may be generated based on user input information associated with the conference, which may be disseminated on the business cards, presentations, and/or conference materials. In this regard, communications received via the shadow address may be categorized as senders from the conference or business cards. Separate shadow addresses may be generated for the other groups (e.g., a second shadow address for the partners, co-workers, and the like), such that communications received via these separate shadow addresses may be categorized appropriately.

Each shadow address may have independently managed settings, permissions, and the like. For example, each shadow address may be associated with a configuration settings set comprising one or more parameters and/or rules for managing the shadow address and/or communications sent or received associated with the shadow address. For example, in some embodiments the configuration settings set comprises a particular communication storage time interval, communication retrieval rates, shadow address termination rules, and the like. Additionally or alternatively, the shadow address may be configured, by a user, as associated with a verified sender shadow address set for whitelisting particular sender addresses, which may be stored in or associated with the address settings set. Additionally or alternatively, the shadow address may be configured, by a user, as associated with a communication permissions set for limiting retrieved communications to be within a particular set of allowed communication types, which may be stored in or associated with the address settings set. For example, a communication permissions set may be configured to only enable receiving text communications, only picture communications, only file communications, or a combination thereof.

In some embodiments, a shadow address is associated with a termination rule, or a termination rule set. For example, a user may generate a shadow address associated with a termination rule that is based on a shadow address termination timer and/or a shadow address communication count. The shadow management system may be configured to track one or more counts and/or timers for determining if a termination rule is satisfied. If a termination rule of the termination rule set is satisfied, the corresponding shadow address may be deleted, disassociated with the base address, or otherwise made irretrievable. For example, the shadow management system may identify a timestamp representing the time at which the shadow address was first generated, which may be used to track the time in which the shadow address was in existence. In other embodiments, the shadow management system may be configured to enable a user to create other termination rules determined based on analysis and/or manipulation of data, information, or other signals associated with the shadow address, including time-in-existence data, time-since-last-use data, communications received data, communications sent data, communication content, and the like.

In some embodiments, additionally and/or alternatively, further processes may be executed to enhance overall system security and/or data security. For example, a base address element that represents a phone number or email address may be transformed or hashed at least once utilizing one or more one-way functions, hash functions, or one or more iterations of one or more one-way or hash functions. Additionally or alternatively, a received communication, or portion thereof, may be encrypted using a symmetric key or a public key associated with the recipient address and shared with the sender during a provisioning or sharing stage, such as at the time the recipient disseminates the shadow address. The encryption enables the controller of the recipient shadow address to decrypt the communication upon retrieval. Such embodiments enable communications to be accessed only by their intended recipients, further improving system security.

In some embodiments, a client device may be configured to enable quick retrieval of communications for all shadow addresses associated with a base address associated with the client device. For example, the client device may store each address construction element set such that the shadow address for each address construction element set may quickly be transmitted to a system, such as a shadow management system, for generating corresponding shadow addresses. The client device may enable each shadow address to be generated such that a user may quickly retrieve communications associated with each shadow address at once.

In some embodiments, communications may be specially configured, formatted, or otherwise include data indicating the communication is associated with a specific meaning, for example a command. A command communication may, for example, embody or represent a command to initiate a specific action, protocol, transfer, transmission, or the like. In this regard, the communication may cause the shadow management system to initiate a corresponding action, or cause a third-party device, system, or the like to initiate the corresponding action, such as by generating and/or transmitting a corresponding action request.

For example, a communication may be configured, structured/formatted, or otherwise include data indicating the communication is for use in logging into a service, for example where the communication includes or is associated with authentication information. Alternatively, a communication may be used to facilitate transactions. For example, the communication may be configured, structured, formatted, or otherwise include data indicating the communication is a request for electronically managed currency or includes a payment of electronically managed currency, and may include information regarding obligations to be performed by the recipient user. In one such example, the communication may include communication contents that indicate the sender user is providing, or owes, a payment amount of electronically managed currency in exchange for a particular purchased good, service, experience, or the like. In some embodiments, a transaction communication may be configured for automatic processing by the shadow management system and/or a recipient client device that retrieves the transaction communication, or may include or otherwise be associated with functionality for facilitating one or more payment processing actions in response to user action associated with the transaction communication. Additionally or alternatively, for example, a communication may be configured, structured, formatted, or otherwise include data indicating the communication is a request to transfer electronically managed currency to a recipient account. In some embodiments, the shadow address may embody, or be associated with, an electronically managed account for storing funds to facilitate such transfers. The shadow management system and/or the client device may be configured to initiate an action, such as an electronic payment transaction, based on the received transaction communication using one or more APIs.

A shadow address may also be used to validate a user and login to a service, such as a service maintained or otherwise supported by the embodiment, an associated system, or a third-party entity. For example, a user may register a third-party service account using a shadow address. The user may provide the base address element and appropriate address construction elements for creating the shadow address associated with the service. Embodiments may validate or confirm the identity of the user via the base address element, for example using a DAA process such as header enrichment, and generate the shadow address to uniquely identify the requesting user and provide the shadow address to log the user into the service. Additionally or alternatively, the user may provide authentication credentials, such as a username and password, which may be associated with the shadow address and/or otherwise utilized for logging into the service. In some embodiments, the shadow management system may communicate with a third-party system, or otherwise facilitate logging into the service, through one or more APIs. Such embodiments improve system security associated with user authentication and confirmation, and enable automatic login of a service while maintaining secure user authentication.

It should be appreciated that, in addition to the examples above, a shadow address may be used in a variety of use cases. Additionally, multiple shadow addresses may also be used, in combination, succession or the like, for similar or additional purposes. The above list represents a non-exhaustive list of examples for descriptive purposes only.

### Definitions

The term “client device” refers to computer hardware and/or software that is configured to access a service made available by a device, system, server, or other hardware, software, or combination thereof, for example one or more server(s) associated with a shadow management system. The server is often (but not always) on another computer system, in which case the client device accesses the service by way of a network. Client devices may include, without limitation, smart phones, tablet computers, laptop computers, wearables, personal computers, enterprise computers, a server associated with a user, an internet of things enabled device (IoT device), and the like. Client devices may be associated with a particular user that owns, controls, otherwise has access to the client device for use. A client device is configured with one or more software applications, browser applications, or the like for accessing the shadow management system.

The terms “carrier header enrichment,” “packet header enrichment,” and “header enrichment process” refer to a process for authenticating a mobile, Internet-of-Things (IoT) device, or other uniquely identified device, or a device owner, via a Direct Autonomous Authentication process, involving a process in which packet headers comprising device identification information, for example, are “injected” into a transmission, or otherwise associated with the transmission, such as by a carrier via a carrier device, network provider, or other entity via a login process. For example, in some embodiments, a network may inject a mobile phone number associated with a mobile device within packet headers of a transmission from the mobile device. In this manner, the device-identity management system may obtain device-identity information associated with a client device, and associated with the user of the client device without user input. application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “base address” refers to electronic data that uniquely is associated with a particular user or client device, and is usable for accessing communications between users and/or one or more electronic services. A base address either generally remains unchanged by the associated user, or is unchangeable. Examples of a base address include, without limitation, a phone number, an email address, a login, an IP address, a MAC address, another electronic network address, a physical home address, another physical address associated with a particular user or client device, or another unique identifier.

The term “element” refers to an electronically managed variable that can be concatenated with other variables, either directly or after conversion. In some embodiments, each element is an electronically managed variable type that may be transformed, via a one-way function or hash function for example, to a predetermined or common type (e.g., hashed generate an integer or string with a set length). Non-limiting examples of an element include a string, an integer, a double-precision floating-point number, a floating-point number, a custom type, a pointer, and a character.

The term “base address element” refers to a unique element associated with a device or a device owner that uniquely represents a base address. For example, without limitation, example base address elements include a string representation of a phone number or a string representation of an email address.

The term “address construction element” refers to an element representing user information, device information, or additional identified, parsed, or randomly generated information for combination with a base address element to generate a unique shadow address. Examples of an address construction element include, without limitation, a string representation of: a random string (which may include an empty string or a null string), a timestamp, a user input nickname, a user input category or label, a file, a public key, a private key, a geolocation, a third-party base address element, a shadow address, or a one-way transformation or hash of any thereof, or a combination thereof. The term “address construction element set” refers to zero or more base address elements.

The terms “one-way transformation function” and “one-way transformation” refer to an algorithm or series of processing steps utilized to generate an output value corresponding to one or more input elements, where inverting the algorithm or series of processing steps to identify the input elements is computationally infeasible or impossible. The term “hash function” and “hashing function” refer to a particular one-way transformation that generates an output of a predetermined type. In some embodiments, a one-way transformation generates an output value of a fixed size regardless of the size of each input element. In some embodiments, for example, a hash function is configured to generate a string of a set length X based on one or more input strings of any length. The one-way transformation function(s) and/or hash function(s) discussed herein are used to generate a shadow address based on a base address element and/or an address construction element set.

The term “shadow address” refers to a unique identifier associated with a base address element via applying the base address element and an address construction element set to a one-way transformation, algorithm, or hash function. A base address element may be associated, or otherwise linked to, one or many shadow addresses based on differing address construction element sets. In some embodiments, communications are received associated with a recipient shadow address and stored as retrievable from a user that accesses the recipient shadow address. Additionally or alternatively, a user may transmit one or more communications from a shadow address to another base address, shadow address, or the like.

The term “shadow address generation request” refers to electronically generated signals transmitted from a client device to a shadow management system indicative of a desire to create a new shadow address. In some embodiments, a shadow address generation request includes a base address element and/or am address construction element set for use in generating a shadow address. A “shadow address generation response” is, in some embodiments, provided in response to a shadow address generation request. In some embodiments, a shadow address generation response includes the generated shadow address.

The term “termination rule” refers to an electronically performed algorithm or process for determining if a shadow address should be deleted, or otherwise disassociated with a base address, such that communications and/or other information associated with the shadow address is irretrievable or otherwise not received. For example, in some embodiments, a termination rule represents a shadow address expiration time, such that the shadow address is deleted after being in existence for the shadow address expiration time. In other embodiments, a termination rule represents a maximum communication count, such that the shadow address is deleted after receiving and/or sending a number of communications equal to the maximum communication count.

The term “communication” refers to structured data including a message transmitted from a user via a sender shadow address or sender base address or other sender identifier to a recipient shadow address. A communication comprises one or more fields including data and/or metadata associated with the communication. For example, a communication may include a “recipient field” that includes a shadow address or other unique address of a recipient address intended to receive the communication. Additionally, in some embodiments, a communication may include a “sender field” that includes a shadow address or other unique address identifier of a sender address that generated or otherwise served as the source of the communication. In some embodiments, a communication additionally or alternatively includes one or more of a communication sent timestamp, a communication body, a communication subject, a communication recipient set, a communication copy set (e.g., a set of recipient addresses cc'd to a communication), communication source location data, or the like.

In some embodiments, a communication is specially configured, structured/formatted, or otherwise indicates the communication has a special purpose. The term “transaction communication” refers to a communication that is associated with, or includes information for initiating, a sale and/or purchase of a good, service, experience, or the like in exchange for electronic currency. The term “login communication” refers to a communication that is associated with, or includes information for completing or continuing, a login and/or user confirmation process for a particular service.

The term “communications set” refers to zero or more communications. In some embodiments, all communications in a communications set may be linked by one or more data fields. For example, a communications set may be formed of all communications associated with a particular recipient address, such as where a recipient field or communication recipient set includes a particular shadow address.

The term “communication transmission signal” or “communication transmission signals” refers to electronically transmitted data or information that represents one or more communications. Communication transmission signal(s) can be parsed to identify a communication or communications set. In some embodiments, communication transmission signal(s) include one or more of transmission metadata, a sender device identifier (for example an IP address), a recipient device identifier (for example an IP address), and/or the like.

The term “communication retrieval request” refers to electronically generated signals transmitted from a client device to a shadow management system indicative of a desire to retrieve and receive, in response, a communications set. In some embodiments, a communications retrieval request includes a base address element and/or an address construction element, or address construction element set, for generating a corresponding shadow address for which communications are to be retrieved. In some embodiments, a communications set associated with a generated shadow address is provided in response to a communication retrieval request.

The term “configuration setting” refers to a parameter associated with receiving, storing, maintaining, and/or retrieving communications associated with a particular shadow address, or a particular business rule, validation check, or electronically performed subroutine associated with receiving, storing, maintaining, and/or retrieving communications associated with the particular shadow address. In some embodiments, one or more configuration setting(s) is configurable, or otherwise may be set, by a user via a client device. In some embodiments, one or more configuration setting(s) is determined and set, or predetermined, by a shadow management system for one or more, or all, shadow addresses. Non-limiting examples of a configuration setting include a verified sender shadow address set, a permissible communication type set, a communication permissions set, a communication expiration period, a maximum stored communication count, a maximum communication retrieval count, or the like. Other non-limiting examples of a configuration setting include business rules for determining when or where a communication may be sent from one or more shadow addresses (e.g., an image communication may only be sent after, or along with, a text communication including no more than 3 characters), when or where a shadow address may be received associated with one or more shadow addresses (e.g., can only retrieve communications during business hours). The term “configuration settings set” refers to zero or more configuration setting(s) active, and/or otherwise associated with, a particular shadow address.

The term “verified sender shadow address set” refers to zero or more shadow addresses or other user addresses whitelisted to transmit communications to a particular shadow address as recipient. In some embodiments, a shadow address is configured such that communications are only received or stored if the communication is received from an address in a corresponding verified sender shadow address set. A user associated with a shadow address may edit a verified sender shadow address set associated with the shadow address.

The term “communication permissions set” refers to one or more rules or limitations that define permissible communication types, content, settings, or the like, to be received by a corresponding shadow address. In some embodiments, a shadow address only receives communications that satisfy a communication permissions set associated with the shadow address, or communications transmitted to be received by the shadow address are only stored if the communications satisfy the communication permissions set associated with the shadow address.

The term “service shadow login request” refers to electronically generated signals transmitted from a client device to a shadow management system indicative of a desire to receive a shadow address for use associated with a service provided via software executed on the client device, and/or a corresponding server. In some embodiments, a service shadow login request includes a base address element and/or an address construction element set for use in generating a corresponding shadow address. The term “service shadow access information” refers to electronically generated signals transmitted from a shadow management system to a client device in response to a service shadow login request. In some embodiments, a service shadow access information includes a shadow address generated based on information provided in a corresponding service shadow login request, where the shadow address is associated with the service. In response to a service shadow login request, a shadow management system may login a user to a third-party service or a service managed by the shadow management system using a corresponding service shadow access information.

### Example System and Apparatuses

The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computing workstation, or a combination thereof. Further, an example embodiment may be embodied by any of a number of mobile terminals, mobile telephones, smartphones, laptop computers, tablet computers, or any combination of the aforementioned devices.

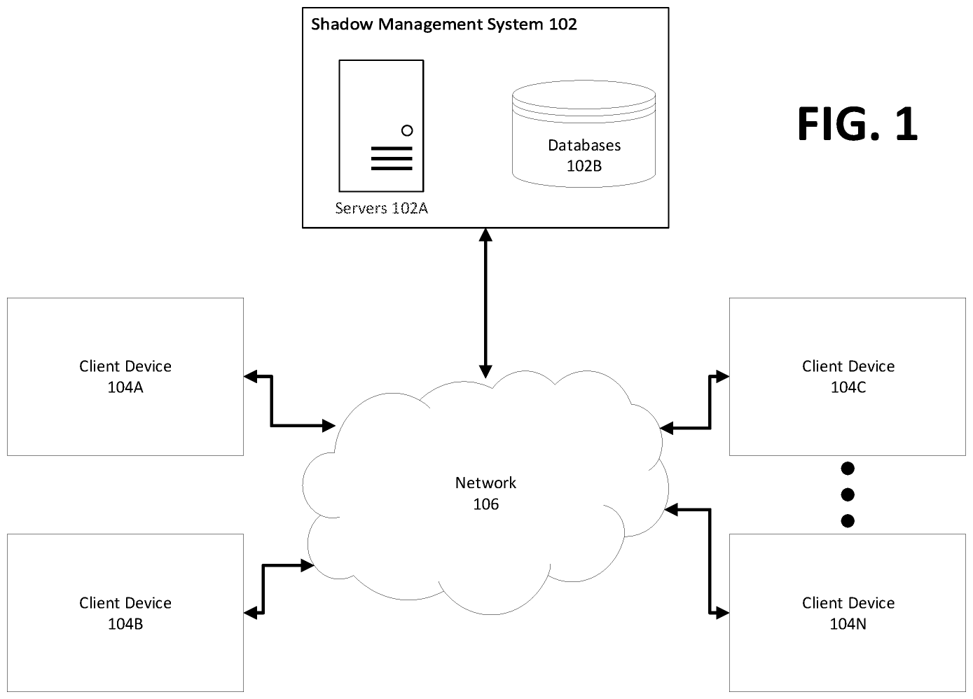

In this regard, FIG. 1 illustrates an example computing system in which embodiments of the present disclosure may operate. FIG. 1 illustrates an overview of a system configured for creation and management of shadow addresses and utilization of created shadow addresses. Specifically, client devices may communicate with a shadow management system for generation and/or management of shadow addresses, and for communicating with uses via shadow addresses. The shadow addresses generated via the shadow management system may additionally or alternatively be utilized to facilitate login to a service, including a third-party service controlled by or otherwise associated with a third-party device or system (not shown).

The system includes a shadow management system 102 and one or more client devices 104A-104N (collectively referred to as “client devices 104”). Any number, or all, of the client devices 104 may be associated with or otherwise embodied by any number of known computing devices. For example, one or more of the client devices 104 may be embodied by a mobile phone, smart phone, tablet, laptop, personal computer, wearable device, set-top box, IoT devices, or the like. One or more of the client devices 104 may be associated with a user entity that rightfully owns, possesses, controls, or otherwise has access to the one or more of the client devices 104. The one or more client device 104 may be secured with one or more user security verification processes for gaining access to functionality provided by the client device (e.g., one or more passcodes, fingerprint, face, or other biometric scan, or the like, or a combination thereof). Accordingly, receiving information (such as a base address element) associated with one of the client devices 104 may serve as a proxy for confirming that a user accessing the client device has successfully been authenticated via the user security verification process(es).

The shadow management system 102 may be embodied by one or more computing systems, apparatuses, devices, or the like, configured for shadow address management and utilization. In this regard, the shadow management system 102 include one or more components, systems, apparatuses, devices, or the like for receiving signals from and/or transmitting signals to third-party devices, including one or more of the client devices 104, and performing one or more of the processes described herein. In some embodiments, the shadow management system 102 may include one or more servers 102A, and one or more databases 102B. The one or more servers 102A may be configured via hardware and/or software to communicate with the one or more client devices over a network, such as the network 106 or sub-networks therein. Additionally or alternatively, the one or more servers 102A may be configured for executing computer-coded instructions for one or more operations for creating a shadow account, editing a shadow account, managing configuration settings for a shadow account, terminating or deleting a shadow account, or otherwise managing shadow accounts, and/or utilizing shadow accounts to facilitate inter-user communication, service login, or other user-verified or facilitated actions.

The databases 102B may be embodied by one or more hardware and/or software systems for storing, retrieving, and/or managing data associated with managing shadow accounts and utilizing shadow accounts. In some embodiments, the databases 102B may be configured to store at least user information, base address elements, one or more shadow addresses, communications and associated data and/or communication metadata. client device information, third-party device information (such as associated with a service provider device configured for enabling access to a service via a client device), or the like. The databases 102B may be embodied by one single database, or a plurality of databases. In some embodiments, the databases 102B may be embodied by a database having multiple sub-databases or sub-repositories therein. For example, a sub-database may include only a specific type of information (e.g., user information), such that a separate database is maintained for each type of user information. It should be appreciated that each database may include any number of sub-databases, tables, and/or other configurations.

The databases 102B may be embodied by any number and/or combination of known data storage devices and configurations. In some embodiments, the databases 102B may include at least one module configured via hardware, software, or a combination thereof In some embodiments, the databases 102B may include at least one data storage device, such as one or more memories, hard disks, network attached storage (NAS) device(s)or a separate database server or servers. The database(s) 102B may be configured to store specific information, data, and/or signals received over a network or generated, or determined, by operations performed by the shadow management system 102. For example, the databases 102B may store user information, shadow address information, third-party service information, or the like.

The system includes network 106 for facilitating communication between the client devices 104 and shadow management system 102. In some embodiments, the network 106 includes one or more sub-networks comprising a combination of shared and/or independent network devices. For example, network 106 may be embodied by, or include a sub-network embodied by, a carrier network comprising at least one carrier device controlled by a carrier entity, such as a mobile phone carrier entity. One or more of the client devices 104 may communicate with the shadow management system 102 via the carrier network, for example embodied by network 106 or a sub-network of network 106, to enable one or more DAA processes including a header enrichment process. In this regard, the carrier network may be an out-of-band network with respect to one or more other sub-networks or other networks associated with the network 106 to prevent channel-based cyber-attacks and ensure verifiability of a received base address element. In some embodiments, the shadow management system 102 may include a carrier device serving as an end-point for packet header enrichment via the carrier network. In other embodiments, the network 106 may be embodied by any number of known networks configurations, including, without limitation, one or more Wi-Fi networks, LAN networks, WLAN networks, and the like, comprised of any number and/or combination of known network devices.

The processor 202 may be embodied in any number of different ways and may, for example, include one or more processing devices configured to perform independently. Additionally or alternatively, the processor may include one or more processors configured in tandem with a bus to enable independent execution of instructions, pipelining, and/or multi-threading. The use of the terms “processor,” “processing module,” and “processing circuitry” may be understood to include a single core processor, a multi-core processor, multiple processors internal to the apparatus, and/or remote or “cloud” processors.

In an example embodiment, the processor 202 may be configured to execute instructions stored in the memory 204, or otherwise accessible to the processor. Additionally or alternatively, the processor 202 may be configured to execute hard-coded functionality. As such, whether configured by hardware methods, software methods, or a combination thereof, the processor 202 may represent an entity (e.g., physically embodied in the circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 206 that may, in turn, be in communication with processor 202 to provide output to the user and, in some embodiments, to receive an indication of user input. The input/output module 206 may comprise a user interface, which may include a display controlled by or associated with a web interface, a mobile application, and/or another user interface, or the like. In some embodiments, the input/output module 206 may include a keyboard, a mouse, a touch screen, touch areas, soft keys, a microphone, a speaker, or other input/output mechanisms. The processor and/or user interface module comprising the processor may be configured to control one or more elements of a user interface through computer program instructions (e.g., software and/or firmware) stored on a memory accessible to the processor 202, such as memory 204 and/or the like.

The communications module 208 may be any means, such as a device, module, and/or circuitry, embodied in either hardware or a combination of hardware and software, that is configured to receive and/or transmit data from and/or to another device, module, circuitry, or the like, in combination with the apparatus 200. The communications module 208 may include means to communicate with remote devices (such as one or more of the client devices 104) via one or more networks. In this regard, the communications module 208 may include, for example, one or more network interfaces for enabling communications with one or more wired or wireless communication networks. For example, the communications module 208 may include one or more network interface cards, antennas, buses switches, routers, modems, and supporting hardware and/or software, or any other device suitable for enabling communications via network (or multiple networks). Additionally or alternatively, the communications module 208 may include a communications interface including circuitry for interacting with the antenna(s) to cause transmission of signals via the antenna(s), and/or to handle receipt of signals via the antenna(s).

In some embodiments, for example, communications module 208 includes means, such as hardware and/or software modules for receiving, routing, and/or transmitting specially configured signals and/or requests. For example, the communications module 208 may include software and/or hardware modules, for receiving communication transmission signals. Additionally or alternatively, in some embodiments, communications module 208 includes means, such as hardware and/or software modules, for receiving a communication retrieval request. Additionally or alternatively, in some embodiments, communications module 208 includes means, such as hardware and/or software modules, for transmitting one or more communications, a communications set, or corresponding signals, to one or more client devices, third-party devices, or the like. Additionally or alternatively, in some embodiments, communications module 208 includes means, such as hardware and/or software modules, for providing a shadow address to a client device, third-party device, or the like. Additionally or alternatively, in some embodiments, communications module 208 includes means, such as hardware and/or software modules, for providing service shadow access information to a client device, third-party device, or the like.

The authorization module 210 includes hardware, software, or a combination thereof, for receiving, parsing and/or identifying, and/or authenticating a base address element. The base address element may be authenticated through one or more authentication processes. For example, the authentication module 210 include means, including hardware, software, and/or a combination thereof, to perform a DAA process. In example embodiments, the authorization module 210 includes hardware, software, and/or a combination thereof, for authenticating a base address element to confirm the identity of the user associated with a client device. In some embodiments the authorization module 210 is configured to authenticate or otherwise verify the base address element via a packet header enrichment process, a login or user credentials authentication process, and/or another verification process. In other embodiments, the authorization module 210 is configured to authenticate or otherwise verify the base address element by validating authentication information received from a client device associated with the base address element. In some embodiments, the authorization module 210 may include a separate processor, specially configured field programmable gate array (FPGA), or application specific interface circuit (ASIC). The authorization module 210 may be configured to perform one or more additional and/or alternative functions, and/or partial operations or whole operations described with respect to the other modules as illustrated.

The shadow account management module 212 includes hardware, software, or a combination thereof, for generating, managing, and utilizing shadow management accounts for verification. In some embodiments, the shadow account management module 212 includes means, such as hardware, software, and/or a combination thereof, for generating a shadow address based on a base address element and an address construction element. The shadow account management module 212 may further be configured to store the shadow address associated with the base address element, or otherwise stored such that it is retrievable by re-generating the shadow address.

Additionally or alternatively, in some embodiments, the shadow account management module 212 includes hardware, software, or a combination thereof, for utilizing shadow addresses for verification, validation, and authorization. For example, the shadow account management module 212, in some embodiments, includes hardware, software, or a combination thereof, for performing a third-party service login utilizing a shadow address or base address element and address construction element set. In some embodiments, the shadow address management module 212 may be configured to identify, retrieve, or generate authentication information upon confirmation that a user is associated with a particular shadow address (for example, via a DAA process such as a header enrichment process). The shadow address management module 212 may be configured to communicate with one or more third-party devices, systems, or the like, and parse information received from the third-party devices, systems, or the like.

In some embodiments, the shadow account management module 212 may include, or otherwise leverage, a separate processor, specially configured FPGA or ASIC. Additionally or alternatively, the shadow account management module 212 may be configured to perform one or more additional and/or alternative functions, and/or partial operations or whole operations described with respect to the other modules as illustrated.

The shadow transmission management module 214 includes hardware, software, or a combination thereof, for receiving, storing, managing access to, and/or transmitting user communications between client devices. The shadow transmission management module 214, in some embodiments, includes hardware, software, or a combination thereof, to communicate with client devices and/or otherwise receive communications from one or more client devices. Each communication received may be associated with a particular sender shadow address, and may be associated with one or more recipient shadow address(es). Additionally or alternatively, in some embodiments, the shadow transmission management module 214 includes hardware, software, or a combination thereof, to store received communications. The communications may be stored such that they are retrievable by a client device authenticated associated with a corresponding shadow address where that shadow address is a recipient shadow address, or in some embodiments is a sender shadow address, of the communication. The shadow transmission management module 214, in some embodiments, is configured to store received communications for an expiration period, such that the communications are deleted after the expiration period lapses. For example, the shadow transmission management module 214 may store the expiration period as a configuration parameter associated with the corresponding recipient shadow address, or as a parameter associated with each received communication.

Shadow transmission management module 214, in some embodiments, is configured to validate that received user communications satisfy configuration settings or requirements set by a user associated with a recipient shadow address. For example, each shadow address may be associated with a configuration settings set that a user may customize based on their preferences. The shadow transmission management module 214 may retrieve the configuration settings set and/or verify that a receive communication satisfies some or all of the settings. For example, a new communication is received that identifies a particular sender shadow address and a particular recipient shadow address, and where the configuration settings set for the recipient shadow address includes a verified sender shadow address set, and the shadow transmission management module 214 may verify the sender shadow address is within the verified sender shadow address set. The shadow transmission management module 214, in some embodiments, is configured to perform one or more similar verification processes based on the configuration settings set.

Additionally or alternatively, in some embodiments, the shadow transmission management module 214 is configured to manage received communication transmission signals. In some embodiments, the shadow management module 214 includes means, such as hardware and/or software modules, configured to store received communications, for example identified from communication transmission signal(s), in one or more databases, repositories, or the like. In some embodiments, a central database associated with the apparatus 200, for example a database embodying databases 102B via hardware, software, or a combination thereof, may be updated to include a newly received communication, such that the newly received communication is retrievable based on the recipient shadow address(es) and/or sender shadow address. Additionally or alternatively, a portion of a communication and/or metadata associated with a communication may be stored. The metadata, for example, may include a sender shadow address, a sender base address, a recipient shadow address public key, a sender shadow address public key, a communication received timestamp, a sender geolocation indicator, a counter value, and/or any other associated string (including a randomly generated sting). In some embodiments, the shadow transmission management module 214 hashes or transforms data associated with or embodying a communication or a portion thereof, and/or the associated metadata, before storing.

In some embodiments, the shadow management module 214 includes software and/or hardware modules for identifying a base address element associated with a client device, and/or received communication transmission signal(s). For example, in some embodiments, the shadow management module 214 includes hardware and/or software configured to identify the base address element via a header enrichment process. In other embodiments, the shadow management module 214 includes hardware and/or software configured to identify the base address element by parsing the base address element from received communication transmission signal(s) and/or extracting the base address element from received communication transmission signal(s). Additionally or alternatively, in some embodiments, the shadow management module 214 includes software and/or hardware configured for identifying an address construction element set associated with a client device and/or communication transmission signal(s). In some embodiments, for example, the shadow management module 214 includes software and/or hardware configured for identifying the address construction element set by parsing and/or extracting the address construction element set from received communication transmissions signal(s).

The shadow transmission management module 214 may, additionally or alternatively, include software, hardware, or a combination thereof, for enabling retrieval of stored communications. For example, the shadow transmission management module 214 may be configured to receive a communication retrieval request. The shadow transmission management module 214, alone or in conjunction with one or more other modules such as authorization module 210 and/or shadow address management module 212, may be configured to identify a base address element and an address construction element set associated with the request, and to generate a corresponding shadow address. Additionally, the shadow transmission management module 214 may be configured to retrieve stored communications, for example a communication set, associated with the generated shadow address. The shadow transmission management module 214 may be configured to query a database, blockchain storage, ledger, or the like for communications associated with the generated shadow address, and receive the communications set in response to the query. The shadow transmission management module 214 may further be configured to transmit the communications set to a client device, for example in response to an earlier received request.

In some embodiments, the shadow transmission management module 214 generates and/or manages a blockchain configured to store the communications and/or associated information. In some embodiments, the shadow transmission management module 214 is configured to store all communications on a single blockchain. Alternatively, in other embodiments, the shadow transmission management module 214 is configured to store communications in multiple blockchains each associated with a particular shadow address or shadow address set. For example, blockchains may be managed based on sender shadow address of the communication, recipient shadow address of the communication, or a combination of sender and recipient shadow addresses. The shadow transmission management module 214 may utilize a blockchain to store communications or portions thereof, and/or associated metadata, temporarily or permanently. For example, each blockchain may be stored associated with a particular expiration period.

In some embodiments, the hash function used to generate blocks for the one or more blockchain(s) utilize information included in or associated with the communication to be stored. For example, the hash function may utilize the communication content, the sender shadow address, the recipient shadow address, the recipient public key, the sender public key, a communication sent timestamp, sender location data, a communication counter, a user input element (e.g., a user input string, number, or the like), and/or a randomly generated element (e.g., a randomly generated string, number, or the like), or a combination thereof In other embodiments, the hash function may utilize a hash of any of the previously mentioned components. Alternatively, in some embodiments, the hash function may utilize a combination of hashed and non-hashed components. For example, a particular example hash function may utilize at least a hash of the communication content, and a non-hashed recipient public key.

In some embodiments, the shadow transmission management module 214 may include, or otherwise leverage, a separate processor, specially configured FPGA or ASIC. Additionally or alternatively, the shadow transmission management module 214 may be configured to perform one or more additional and/or alternative functions, and/or partial operations or whole operations described with respect to the other modules as illustrated.

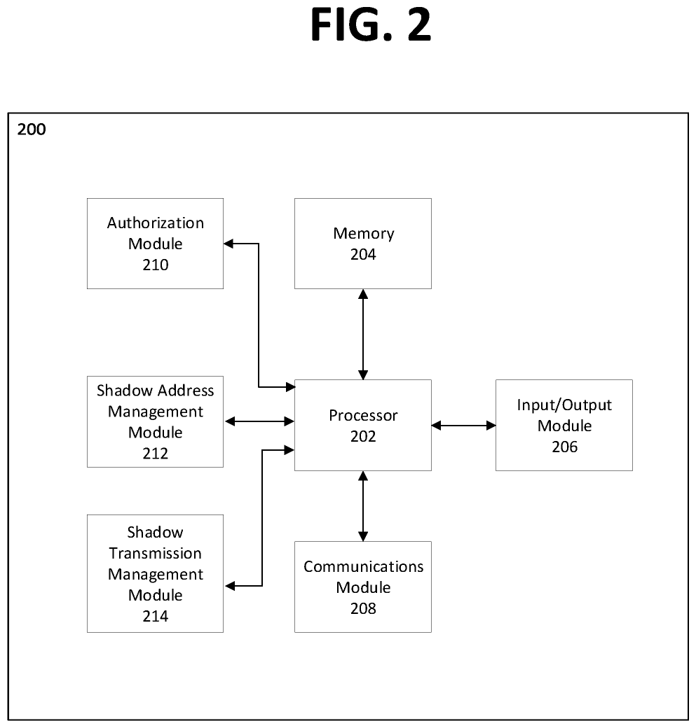

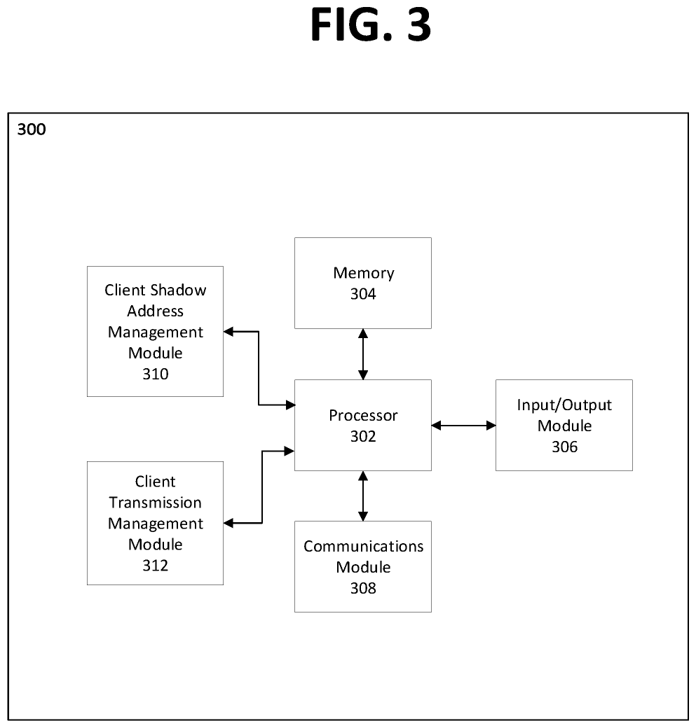

Client device(s) 104 may be embodied by one or more computing systems, such as apparatus 300 shown in FIG. 3. As illustrated in FIG. 3, the apparatus may include a processor 302, memory 304, input/output module 306, and communications module 308. As it relates to operations described in the present disclosure, the functioning of the processor 302, the memory 304, the input/output circuitry 306, and the communications circuitry 308 may be similar to the similarly named components described above with respect to FIG. 2, and for the sake of brevity, additional description of the mechanics and functionality of these components is omitted. Nonetheless, these device components, whether operating alone or together, provide the apparatus 300 with the functionality necessary to facilitate the communication of data and information between client devices and/or third-party devices.

The client shadow address management module 310 includes hardware, software, or a combination thereof, for enabling access to one or more shadow addresses for management and utilization, via a shadow management system. In this regard, the client shadow management module 310 may be configured to perform one or more operations for managing and utilizing one or more shadow addresses, and provide notification or such operations to the shadow management system, such as for synchronization on the shadow management system. In some embodiments, the client shadow address management module 310 includes hardware, software, or a combination thereof, for receiving and/or identifying information as a base address element. In a particular example embodiment, the client shadow address management module 310 may be configured to identify a phone number associated with the apparatus 300 for verification.

In some embodiments, the client shadow address management module 310 includes hardware, software, or a combination thereof, for storing a unique identifier associated with a user entity. Additionally or alternatively, in some embodiments, the client shadow address management module 310 includes hardware, software, or a combination thereof, for receiving identifying information associated with the unique user identifier via user input. Additionally or alternatively, in some embodiments, the client shadow address management module 310 includes hardware, software, or a combination thereof, for storing identifying information associated with a unique user identifier. Additionally or alternatively, in some embodiments, the client shadow address management module 310 includes hardware, software, or a combination thereof, for receiving user input indicative of a request to generate a shadow address, for example a shadow address associated with a unique user identifier.

Additionally or alternatively, in some embodiments, the client shadow address management module 310 includes hardware, software, or a combination thereof, configured for generating, activating, and/or managing configuration settings associated with one or more shadow addresses. For example, where the apparatus 300 is associated with a particular base address (e.g., a particular phone number), the client shadow address management module 310 may enable management of all shadow addresses associated with the base address, such as where the base address corresponds to a base address element for each of the shadow addresses. The client shadow address management module 310, in some embodiments, includes hardware, software, or a combination thereof, for generating, deleting, and/or editing a verified sender shadow address set. For example, a user may include a new shadow address as a verified sender, such that communications may be received when the new shadow address is the sender shadow address. In some embodiments, the client shadow address management module 310 may receive the new shadow address via user input. Additionally or alternative, in some embodiments, the client shadow address management module 310 is configured for generating, deleting, or editing a communication permissions set. For example, a communication permissions set may be generated and/or edited associated with a particular shadow address to limit the communications receivable associated with that shadow address based on the communication type. Communications may be limited for all sender shadow addresses (e.g., all shadow addresses can only send text communications, or only image communications, or only file communications, or the like), or customized for each sender shadow address (shadow address A may send text communications or image communications, shadow address B may only send image communications, shadow address C may only send file communications, or the like).

The client shadow address management module 310 may, alone or in conjunction with one or more other modules, generate and render, or cause rendering of, one or more interfaces for performing the above operations. For example, the interface may include one or more known shadow addresses that a user has previously communicated with or received communications from, and/or user inputs for receiving new shadow addresses, as well as interface components for editing configuration settings associated with such shadow addresses. In some embodiments, the client shadow address management module 310 is embodied entirely of software configured to perform one or more of the above operations in communication with other software executed via the apparatus 300, for example contact management software.

In some embodiments, the client shadow address management module 310 may include, or otherwise leverage, a separate processor, specially configured FPGA or ASIC. Additionally or alternatively, the client shadow address management module 310 may be configured to perform one or more additional and/or alternative functions, each of which may be associated with the operations described above. Further, in some embodiments, the client shadow address management module 310 is configured to perform one or more partial operations or whole operations described with respect to one of the other modules as illustrated.

The client transmission management module 312 includes hardware, software, or a combination thereof, for enabling generation and/or transmission of communication with another shadow address, via a shadow management system. In some embodiments, the client transmission management module 312 is configured for selecting and/or inputting one or more recipient shadow addresses to which a communication is to be generated and sent. Additionally or alternatively, the client transmission management module 312 is configured, in some embodiments, to generate a communication for transmission to the selected and/or input recipient shadow addresses via a shadow management system, and transmit the communication, or corresponding information, to the shadow management system.

In some embodiments, the client transmission management module 312 is configured to parse, extract, and/or otherwise identify a base address element and/or an address construction element set associated with a sender shadow address. For example, the client shadow address management module 310 may be configured to store and/or otherwise manage a base address for use in generating and/or transmitting a base address clement. Additionally or alternatively for example, the client shadow address management module 310 may be configured to parse, extract, and/or identify contact information associated with a particular contact for use in generating and/or transmitting an address construction element set. In an example embodiment, for example, a sender shadow address may be constructed from a unique identifier stored associated with a particular recipient shadow address (e.g., a user input description for the recipient), which may be managed by the client transmission management module 312 and retrieved for transmission upon selection, by the sending user, to communicate with that recipient shadow address.

In this regard, the client transmission management module 312 may include hardware, software, or a combination thereof, for generating, retrieving, and/or otherwise causing rendering of interfaces for performing one or more of the above operations. For example, in some embodiments, the client transmission management module 312 is configured to generate and/or cause rendering of one or more communication interfaces for selecting one or more recipient shadow address(es) and inputting communication content (e.g., text content, one or more image(s), and/or one or more file(s), or the like). The client transmission management module 312 may, alternatively or additionally, be configured for selecting or inputting additional address construction elements for generating the corresponding sender shadow address.

In some embodiments, client transmission management module 312 includes software, hardware, or a combination thereof, alone or in combination with one or more other modules, for transmitting a shadow address creation request to a shadow management system. Additionally or alternatively, in some embodiments, client transmission management module 312 includes software, hardware, or a combination thereof, for rendering one or more representations of a shadow address. Additionally or alternatively, in some embodiments, client transmission management module 312 includes software, hardware, or a combination thereof, for providing a shadow address to a second client device.

In some embodiments, the client transmission management module 312 may include, or otherwise leverage, a separate processor, specially configured FPGA or ASIC. Additionally or alternatively, the shadow account management module 212 may be configured to perform one or more additional and/or alternative functions. In some embodiments, the shadow account management module 212 may be configured to perform partial operations or whole operations described with respect to the functionality of the other modules as illustrated.

It should be appreciated that one or more of the modules 202-214 may be combined to form one module that performs the function of multiple modules. In some embodiments, for example, each of the modules 210-214, or 206-214, may be embodied entirely in one or several software modules for execution in conjunction with the processor 202 and/or memory 204.

Similarly, it should be appreciated that one or more of the modules 302-312 may be combined to form one module that performs the function of multiple modules. In some embodiments, for example, each of the modules 310-312, or 306-312, may be embodied entirely in one or several software modules for execution in conjunction with the processor 302 and/or memory 304.

As will be appreciated, any such computer program instructions and/or other type of code may be loaded onto a computer, processor, and/or other programmable apparatus' circuitry to produce a machine, such that a computer, processor, or other programmable circuitry that executes the code on the machine creates the means for implementing various functions, including those described herein. For example, in some embodiments, one or more of the modules may be entirely embodied by one or more software modules for performing the functions identified.

As described above, and as will be appreciated based on the disclosure, embodiments of the present disclosure may be configured as methods, mobile devices, backend network devices, and the like. Accordingly, embodiments may comprise various means embodied of entirely hardware, entirely software, or a combination of hardware and software. Further, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, flash memory, CD-ROMs, optical storage devices, magnetic storage devices, or the like.

### Example Data Flow

Having thus described an example system and example apparatuses, an example data flow will now be described. It will be appreciated that the described data flows, operations, processes, and the like are non-limiting examples, and embodiments may perform various data flows in a myriad of ways and using various systems configurations.

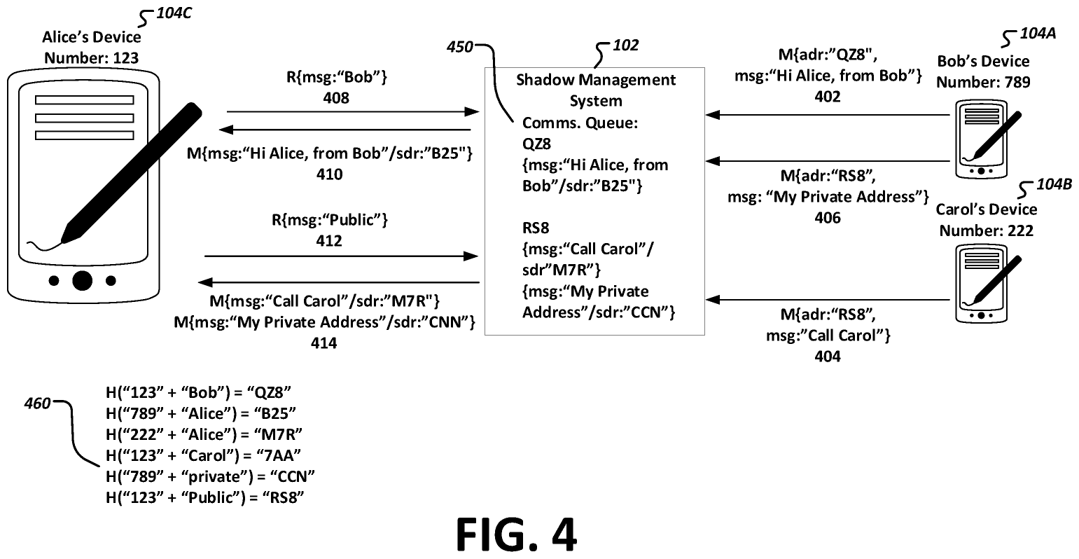

FIG. 4 illustrates a data flow diagram depicting steps between system components for facilitating communication between client devices via a shadow management system, in accordance with an example embodiment of the present disclosure. Specifically, the data flow diagram illustrates operations for transmitting communications from client devices to a shadow management system, and retrieval of communications from the shadow management system by client devices. The shadow management system, for example shadow management system 102, may be embodied by one or more computing devices, systems, or apparatuses, for example apparatus 200. The client devices, for example client devices 104A-C, may each be embodied by one or more computing devices, systems, or apparatuses, for example apparatus 300.

Shadow management system 102 includes communication queue 450, which includes a communication set to be transmitted to shadow addresses associated with the depicted client devices. As illustrated, the communication set is retrieved by Alice's device 104C, but in other embodiments Alice could provide a base address element and address construction element set via another client device to facilitate retrieval. The communication queue 450 may be embodied using a myriad of devices, systems, apparatuses, modules, or the like. For example, in some embodiments, communication queue 450 is embodied by one or more databases, for example databases 102B. In other embodiments, communication queue 450 may be embodied by a sub-repository, table, view, or one or more blockchains. Communication queue 450 is maintained by shadow management system 102 to include communications transmitted by sender shadow addresses, but not yet retrieved by a recipient shadow address. It should be appreciated that the communication queue may be configured to store, or may be associated with one or more other communication queues configured to store, communications transmitted to one or more other recipient shadow addresses (not depicted). In some embodiments, communication queue 450 is embodied by a central database for storing communications associated with each recipient shadow address.

Each of the client devices 104A-104C, as illustrated, are associated with a corresponding base address, for example a mobile phone number or other unique identifier. In some embodiments, the base address links the client device to a particular base address such that the base address may be received and/or validated through a DAA process, for example through a header enrichment process. For example, Alice's device 104C is associated with base address 123, which may be represented as a base address element having a string type as “123.” Bob's device 104A is associated with base address 789, which may be represented as a base address element having a string type as “789.” Carol's device is associated with base address 222, which may be represented as a base address element having a string type as “222.”

Each user device may be associated with one or more shadow addresses. Each shadow address, in some embodiments, is generated from application a base address element, address construction elements, or a combination thereof, to one or more one-way transformation or hash functions. For example, the client devices 104A-104C may be associated with the shadow addresses 460. Alice's device 104C, for example, may be associated with three different shadow addresses. The shadow addresses associated with Alice's device may be generated using the same base address element (e.g., “123”) and a different address construction element set. In particular, the user of Alice's device 104C may create a first shadow address for communicating with Bob, and the address construction element “Bob” may be utilized to generate the corresponding shadow address. The address construction element “Bob” may be parsed and/or extracted from Alice's device 104C, for example where “Bob” is an identifier used to identify Bob's base address or shadow address in Alice's device 104C.

The address construction element set may then be transmitted, with the base address element to the shadow management system 102. The shadow management system 102 may apply the base address element and the address construction element set to the hash function, or another transformation function such as any one-way transformation function, to generate a shadow address. In some embodiments, the address construction element set are concatenated, or otherwise utilized in conjunction with the base address element, to generate a complete address for hashing. For example, as depicted in shadow addresses 460, the shadow address generated for Alice's device associated with Bob's device may be H(“123”+“Bob”), which results in the shadow address of “QZ8.” This shadow address maybe provided to and stored by Alice's device 104C, and/or rendered to an interface associated with Alice's device 104C, for sharing or otherwise providing to Bob's device 104A, such that Bob's device 104A may communicate with Alice's device 104C via the shadow address. Alice's device 104C may further generate, via the shadow management system 102, a shadow address to be provided for communication with Carol's device 104B. For example, as depicted in shadow addresses 460, Alice's device 104C may identify Carol's device 104B as “Carol,” which may be provided as an address construction element together with the base address element of “123.” By applying the hash function, for example, the shadow management system 102 generates the corresponding shadow address “7AA.” This shadow address maybe provided to and stored by Alice's device 104C for rendering or providing to Carol's device 104B, such that Carol's device 104B may communicate with Alice's device 104C via the shadow address. In this regard, while Alice's device 104C is associated with a single base address, which in other embodiments may be a mobile phone number or an email address, Carol's device 104B and Bob's device 104A may communicate with Alice's device 104C via different private shadow addresses, enabling independent configuration of each shadow address or disassociation of one of the shadow addresses without affecting the connectivity of the other.

Alice's device may further, via the shadow management system 102, be associated with one or more shadow address(es) intended for use by groups of users or otherwise unknown senders. For example, Alice's device 104C may generate a public shadow address intended to receive communications from a particular public group of users, such as a shadow address to be included on marketing or publication materials. The user of Alice's device 104C may input one or more address construction element(s) for use in generating a corresponding shadow address, for example the string “Public” as used to generate the corresponding shadow address in shadow addresses 460. As depicted in shadow addresses 460, the shadow management system 102 applies the base address element and the address construction element set (e.g., the string “Public”) to the hash function to generate the corresponding shadow address “RS8.” This shadow address may be provided to and stored by Alice's device 104C for rendering or providing to any number of users to receive communications via each user's corresponding client device.

It should be appreciated that each of Bob's device 104A and Carol's device 104B may each also be associated with one or more shadow addresses. For example illustrative purposes, as depicted in shadow addresses 460, Carol's device 104B is associated with only a single shadow address. In particular, this shadow address is generated for communication with Alice's device 104C, and is generated by applying the base address element for Carol's device 104B (“222”) and an address construction element set comprising a single address construction element (“Alice”) to a hash function or other one-way transformation function, which generates the corresponding shadow address “M7R.” The single address construction element may be extracted or parsed from Carol's device 104B, for example from a user entered identifier for Alice's device 104C, or may otherwise be input by a user of Carol's device 104B. Bob's device 104A is associated with two shadow addresses. Specifically, Bob's device 104A is associated with a first shadow address (“B25”) utilized to communicate with the shadow address “QZ8” that Alice's device 102C shared with Bob's device. Similar to the previous shadow addresses, this shadow address may be generated by applying the base address element for Bob's device 104A (“789”) and an address construction element set comprising a single address construction element (“Alice”), where the address construction element is extracted or parsed from Bob's device 104A or input by a user of Bob's device 104A. Additionally, Bob's device 104A is associated with a second shadow address (“CCN”) used to communicate with Alice's device's public address “RS8.” This shadow address may be generated by applying the base address element for Bob's device 104A (“789”) to an address construction element set comprising another single address construction element (“private”), which for example may be input by a user of Bob's device 104A.

In some embodiments, a user device may be configured to provide functionality for sharing generated shadow addresses with one or more users. For example, Alice's device 104C may be configured to render the shadow address provided by the shadow management system 102, which the user of Alice's device 104C may then communicate, in person, to the user of another device. Alternatively or additionally, Alice's device 104C may provide functionality to share the shadow address electronically, for example via a messaging application, email, text message, or the like. Alternatively or additionally, the shadow management system 102 may provide the shadow address in an encoded and/or otherwise decodable representation, including, but not limited to, binary representations, text representations, image representations, and the like. In some embodiments, the shadow address may be provided as a scannable representation, which enables another user to scan and decode the shadow address scannable representation. For example, the shadow address may be provided and/or rendered as a QR code, bar code, or the like.

For example purposes, the hash function illustrated generates a three-character shadow address based on the base address element (e.g., as illustrated, the number associated with each client device) and an address construction element set (e.g., as illustrated, an identifier associated with whom the shadow address is to be used for communications with, or a user-input or user-determined string). It should be appreciated that the examples provided are for illustrative and descriptive purposes, and in other embodiments alternative base address elements (e.g., mobile phone numbers) may be used, and/or alternative and/or additional address construction elements. For example, in some embodiments an address construction element set may include two or more address construction elements. In some such embodiments, each address construction element in the address construction element set may be combined to form a combined address construction element for applying to a hash function.

It should be appreciated that, in some embodiments, generating a shadow address may occur entirely by a client device, entirely by the shadow management system 102, or in combination thereof. For example, in some embodiments, Alice's device 104C may generate a shadow address by applying the hash function to Alice's device's base address and a corresponding address construction element set without communication with the shadow management system 102. In some embodiments, the shadow management system 102 may then re-generate the shadow address upon receiving a communication to verify the shadow address generated by the client device is not fraudulent or otherwise improper. For example, in this regard, the shadow management system 102 may verify the base address element utilized to generate the shadow address is associated with the client device, such as through a header enrichment process, other DAA process, or another confirmation process. Advantageously, in such embodiments, networking and server computing resources may be saved during shadow address generation while maintaining security.

Having explained the generated shadow addresses, FIG. 4 further illustrates an example flow of communications between client devices 104A-104C. It should be appreciated that the steps illustrated are for illustrative and descriptive purposes, and not for purposes of limiting the scope or spirit of the disclosure. In other embodiments, different base addresses, base address elements, address construction elements, and/or any combination thereof, may be utilized. Additionally or alternatively, in other embodiments, a different number of client devices and/or configuration of client devices may be utilized, or a different data flow between client devices.

In some embodiments, a client device generates and/or transmits one or more communication transmission signal(s) comprising, or otherwise associated with, a communication. For example, the communication transmission signal(s) may include one or more communications, or associated information, metadata associated with the one or more communications, and identification information for a recipient device, system, or the like intended to receive the communication transmission signals. In this regard, the communication transmission signal(s) may, at least, include an IP address or other identifier associated with the shadow management system, and/or an IP address associated with a third-party system and/or a client device. In some embodiments, the communication transmission signals embody a sent communication or sent communication set.

A communication may include or otherwise be associated with various fields, parameters, or the like. For example, as depicted, each communication may be associated with a sender shadow address (“sdr”), one or more recipient shadow addresses (“adr”), and communication contents depicted as text communication contents (“msg”), for example. It should be appreciated that in some embodiments, a communication may be associated with one or more recipient shadow addresses, for example where each communication includes a recipient shadow address set. In some embodiments, the shadow management system 102 may be configured to maintain a group identifier associated with a set of shadow addresses formed by a sender address and two or more recipient shadow addresses.

Additionally or alternatively, in some embodiments, a communication may include one or more additional fields, parameters, or the like. For example, in some embodiments, a communication may include a sender address field indicating a sender shadow address. Alternatively or additionally, in some embodiments, a communication may include a base address field indicating a base address element associated with a sender shadow address. Additionally or alternatively, in some embodiments, a communication may include an address construction element set associated with a sender shadow address. In some embodiments, each parameter and/or field, or a subset thereof, may be input by a user via a client device. Alternatively or additionally, a client device transmitting a communication transmission signals associated with one or more communications may automatically identify, retrieve, and/or include one or more parameter(s) and/or field(s) in the communication(s).

At step 402, for example, Bob's device 104A generates and/or transmits a first communication to shadow management system 102. For example, Bob's device 104A may generate and/or transmit communication transmission signals comprising at least the first communication. The first communication may include a recipient shadow address “QZ8,” which corresponds to the shadow address provided to Bob's device 104A from Alice's device 104C. The first communication includes text communication contents of “Hi Alice, from Bob.” The first communication may be transmitted along with, or additional to, a base address element associated with Bob's device (e.g., “789”) and an address construction element set (e.g., a single address construction element of “Alice”).

In some embodiments, Bob's device 104A may encrypt the communication before transmitting to the shadow management system 102. For example, the communication may be encrypted based on a symmetric key shared between Bob's device 104A and Alice's device 104C. The symmetric key may have been generated at the time Bob's device 104A and Alice's device 104C exchanged shadow addresses, and the symmetric key may be stored by both devices. Alternatively, the communication may be encrypted using a public key infrastructure. In this regard, Bob's device 104A, or the associated sender shadow address, may be associated with a public key and private key pair, and Alice's device 104C, or the associated recipient shadow address, may be associated with a second public key and private key pair. In some embodiments, Bob's device 104A obtains and utilizes the public key associated with Alice's device 104C to encrypt the communication, such that it may only be decrypted by Alice's device 104C utilizing the corresponding private key. Additionally or alternatively, the Bob's device 104C may utilize its own private key to sign the communication via a digital signature, such that Alice's device 104C, and/or the shadow management system 102, can confirm the digital signature via the public key associated with Bob's device 104A. Such encryption may improve data security associated with the overall system.

In some examples, a communication may be intended for multiple recipient shadow addresses. In some embodiments, the communication may include, or otherwise be associated with multiple recipient shadow addresses. In some such embodiments, the shadow management system 102 may be configured to store the communication, or a copy of the communication, associated with each recipient shadow address. In this regard, an individual communication may be retrieved by each user associated with each recipient shadow address. The communication, or each copy, may be associated with a shadow address group comprising the multiple recipient shadow addresses. Alternatively, in other embodiments, a client device transmitting a communication associated with multiple recipient shadow addresses may transmit multiple communications each associated with a single recipient shadow address of the multiple recipient shadow addresses. A user may, via a client device, respond to a communication associated with multiple recipient shadow addresses with their own communication. The user may, via the client device, input and/or select one or more recipient shadow addresses, which may or may be based on the multiple recipient shadow addresses and/or sender address of the first received communication. For example, in some embodiments, a user may transmit a response communication to just the sender shadow address associated with a first communication having multiple recipient shadow addresses, transmit the response communication to all other recipient shadow addresses associated with the first communication and the sender shadow address of the first communication, or to a subset thereof In some other embodiments, the shadow management system 102 may facilitate peer-to-peer communications between client devices. In alternative embodiments, the shadow management system 102 supports group communicating using one or more protocols utilized by email communications systems or telecommunication systems.

The shadow management system 102 may identify, validate or otherwise confirm the received base address. For example, the shadow management system may utilize a DAA process to validate the received base address. In some examples, the base address may be a phone number validated automatically via a header enrichment process. In such embodiments, the header enrichment process is a highly secure process to confirm the phone number associated with the sending user device, for example by using SIM technology or another carrier-controlled verification used to bill a mobile device user. Given the high level of security provided by the header enrichment process, in such embodiments, the shadow management system 102 confirms the identity of the sending client device and the received base address element to ensure that communications are transmitted without fraud. In other embodiments, another base address element validation process may be utilized. For example, in some embodiments, the base address may be an email address, and the shadow management system may utilize a login confirmation to validate that the sending user can access the email address.

The shadow management system 102 may be configured to generate the sender shadow address based on the received base address element and address construction element set. For example, the shadow management system 102 may be configured to apply the base address element and the address construction element set to a hash function, or multiple iterations of one or more hash functions, resulting in the sender shadow address. In other embodiments, the first communication may include the sender shadow address “B25,” corresponding to the shadow address associated with Bob's device 104A that is used to communicate with Alice's device's 104C shadow address “QZ8.”

In some embodiments, the shadow management system 102 may be configured to confirm the received communication confirms to one or more shadow address restriction settings. The shadow management system 102 may be configured with one or more algorithms, checks, processes, or the like for determining the communication satisfies the shadow address restriction settings. In some such embodiments, the shadow management system 102 may individually confirm that the communication satisfies each setting in the shadow address restriction settings. It should be appreciated that communications may be restricted based on any number of settings, such that a shadow address restriction setting may be configured for any information embodied in a communication or associated with the communication, including metadata associated with the communication or transmission thereof.

For example, the shadow address may be associated with a verified sender shadow address set. In some such embodiments, the shadow management system 102 may be configured to compare the sender shadow address associated with the first communication to determine if the associated sender shadow address is within the verified sender shadow address set. In some embodiments, the communication is stored if it satisfies the verified sender shadow address set. If the sender shadow address is not within the verified shadow address set, the communication may not be stored, and in some embodiments an error signal may be generated and/or transmitted to the sender client device. The error signal may include a message identifying the restriction setting not satisfied.

In another example, the shadow address may be associated with a communication permissions set. For example, the communication permissions set may restrict stored communications to only be of a particular communication type. For example, communications received associated with the shadow address may be limited to only text communications, only image communications, or only file communications. Alternatively, restricted communication types may be limited based on the sender shadow address. For example, the shadow address “RS8” may be configured to not restrict communication types from sender shadow address “CCN,” associated with Bob's device 104A, but may restrict one or more, or all, other sender shadow addresses (e.g., “M7R” associated with Carol's device 104B) to only a single communication type, such as text communications. If a received communication does not satisfy the communication permissions set, the communication may not be stored, and in some embodiments an error signal may be generated and/or transmitted to the sender client device. The error signal may include a message identifying the restriction setting not satisfied.

The shadow management system 102 may store the received first communication in a database, repository, blockchain, or the like, for example communication queue 450. The communication queue 450 may be separated based on the recipient sender address for each communication. In such embodiments, the first communication may be stored associated with the shadow address “QZ8.” In some embodiments, additional information and/or metadata associated with the first communication is stored. For example, the sender shadow address may be stored associated with the communication, or as part of the communication. Communication metadata may include one or more transmission timestamps, a communication subject, or the like. In some embodiments, only a portion of the received communication is stored, for example only a portion of the communication necessary for reconstructing the communication upon retrieval.

At step 404, Carol's device 104B similarly generates and/or transmits a second communication to shadow management system 102. The second communication may include a recipient shadow address “RS8,” which corresponds to a public shadow address associated with Alice's device 104C. The shadow address, for example, may be a public shadow address provided by the user of Alice's device 104C at the end of a presentation. The user of Carol's device 104B may input the public shadow address from the presentation into Carol's device 104B, for example into contacts software executed on Carol's device 104B such as an address book, to enable communicating via the public shadow address. The second communication includes text communication contents “Call Carol.” The second communication may be transmitted along with, or additional to, a base address element associated with Carol's device 104B (“222”) and an address construction element set (e.g., a single address construction element of “Alice”). The single address construction element may, for example, be parsed and/or extracted from Carol's device 102B. For example, “Alice” may represent an identifier stored in Carol's device 104B associated with Alice's device's public shadow address “RS8.”

Upon receiving the second communication, the shadow management system 102 may again validate or otherwise confirm the received base address element. For example, the shadow management system 102 may utilize a DAA process, a header enrichment process, a login process, or another confirmation process. In this regard, the shadow management system 102 validates that the base address is associated with Carol's device 104B, or otherwise accessible to the user of Carol's device 104B. The shadow management system 102 may then generate the sender shadow address based on the received base address element and the address construction element set. For example, the shadow management system 102 may be configured to apply the base address element and the address construction element set to a hash function, or multiple iterations of one or more hash functions, resulting in the sender shadow address. For example, as depicted by shadow addresses 460, the shadow management system 102 may generate a corresponding sender shadow address “M7R.”

The shadow management system 102 may then store the received second communication in the communication queue 450. The second communication may be stored associated with the recipient shadow address “RS8.” The first communication and the second communication may be retrieved upon receiving a communication retrieval request associated with the recipient shadow address for which the communications are stored.

At step 406, Bob's device 104A generates and/or transmits another, third communication to shadow management system 102. The third communication may include a recipient shadow address “RS8,” again corresponding to the public shadow address associated with Alice's device 104C. The user of Bob's device 104A may similarly identify the public shadow address from the end of the presentation provided by the user of Alice's device 104C. The user of Bob's device 104A may input the public shadow address from the presentation into Bob's device 104A, for example into contacts software executed on Bob's device 104A such as an address book, to enable communicating via the public shadow address. The third communication includes text communication contents “My Private Address.” The third communication may be transmitted along with, or additional to, a base address element associated with Bob's device 104A (“789”) and an address construction element set (e.g., a single address construction element “private”). In this regard, the sender shadow address associated with the third communication, as depicted, differs from the sender shadow address associated with the first communication, even though both may be sent from Bob's device 104A. The single address construction element may be input by the user of Bob's device 104A, or otherwise automatically parsed and/or extracted from Bob's device 104A. For example, Bob's device 104A may locally store the address construction element set (as depicted, the single address construction element) associated with the shadow address for transmission to the shadow management system 102 along with or additional to transmitted communications.

Upon receiving the second communication, the shadow management system 102 may again validate or otherwise confirm the received base address element using any of the described processes. Alternatively, Bob's device 104A may provide authentication information, such as an authentication token, based on previous validation. For example, shadow management system 102 may have provided an authentication token in response to receiving the first communication from Bob's device 104A, where the authentication token indicates the shadow management system 102 previously verified the base address associated with Bob's device 104A. In this regard, the shadow management system 102 validates that the base address represented by the base address element for the third communication is associated with Bob's device 104A, or otherwise accessible to the user of Bob's device 104A.

The shadow management system 102 may then generate the sender shadow address based on the received base address element and the address construction element set. For example, the shadow management system 102 may be configured to apply the base address element and the address construction element set to a hash function, or multiple iterations of one or more hash functions, resulting in the sender shadow address. For example, as depicted by shadow addresses 460, the shadow management system 102 may generate a corresponding sender shadow address “CCN.”

The shadow management system 102 may then store the received third communication in the communication queue 450. The third communication may be stored associated with the recipient shadow address “RS8.” In this regard, the third communication may be stored together with the second communication having the same recipient shadow address. It should be appreciated that any number of communications may be received. In some embodiments, any number of received communications may be stored. In other embodiments, the count of stored communications may not exceed a communication storage threshold.

Optionally, in some embodiments, one or more of the communications transmitted to the shadow management system 102 may be encrypted by the client device such that the communication may only be decoded and accessed by a client device associated with the intended recipient. For example, Bob's device 104A may store a symmetric key and/or a public key associated with an identifier of Alice's device 104C or a corresponding shadow address, for example the stored shadow address “QZ8.” The symmetric key and/or public key may have been previously stored, for example when Alice's device 104C, or a corresponding user, shared the corresponding shadow address to enable communication between Bob's device 104A and Alice's device 104C. When sending a communication to Alice's device 104C, or to a particular shadow address, Bob's device 104A may retrieve a stored associated symmetric key and/or public key for use in encrypting the communication before transmitting it to the shadow management system 102. In this regard, the communication may only be decrypted by a device having access to the symmetric key and/or private key corresponding to the stored public key, which should only be Alice's device 104C (or another device trusted by a shared user).

Bob's device 104A may additionally store a private key associated with a public-private key pair associated with Bob's device 104A, or an associated shadow address. Bob's device 104A may utilize the private key to digitally sign communications transmitted to other client devices. In this regard, client devices that retrieve communications can verify that the communication was transmitted by Bob's device 104A. Such embodiments further enhance overall system security by enabling a recipient to confirm that the communication sender's identity.

After step 406, three communications have been transmitted and stored: a first communication sent from a first shadow address “B25” associated with Bob's device 104A to a first shadow address “QZ8” associated with Alice's device 104C; a second communication sent from a second shadow address “M7R” associated with Carol's device 104B to a second, public shadow address “RS8” associated with Alice's device 104C; and a third communication sent from a second shadow address “CCN” associated with Bob's device 104A to the second, public shadow address “RS8” associated with Alice's device 104C. In some embodiments, shadow addresses are not restricted to receive from particular recipients. Thus, although the illustration depicts two communications from two shadow addresses associated with Bob's device 104A to two shadow addresses associated with Alice's device 104C, it should be appreciated that either of the communications could have been sent to the other shadow address. For example, the communications from Bob's device 104A could have both been sent from a single shadow address associated with Bob's device 104A, to a single shadow address associated with Alice's device 104C, and/or both.

At step 408, Alice's device 104C transmits a first communication retrieval request to the shadow management system 102. The communication retrieval request may represent a desire to receive the communications associated with a particular shadow address (or shadow address set). The communication retrieval request may include, or otherwise be associated with, a particular shadow address for which corresponding communications are to be retrieved. For example, the first communication retrieval request may be associated with the base address element “123” for Alice's device 104C, and the address construction element set comprising a single address construction element “Bob.” The address construction element “Bob” may, for example, be a personal identifier stored by Alice's device 104C.

In some embodiments, for example, the base address element is identified, received, or otherwise retrieved via a header enrichment process. For example, where the base address element is a representation of a mobile phone number, the shadow management system 102 may communicate with a carrier device that is configured to perform the header enrichment process and identify the mobile phone number associated with Alice's device 104C. In some embodiments, the carrier device is a sub-system or component of the shadow management system 102. Additionally or alternatively, in some embodiments, the shadow management system 102 communicates with the carrier device via one or more application programming interfaces (APIs). In other embodiments, the DAA, header enrichment, or other verification process may be executed by an authentication system configured to communicate with Alice's device 104C. In such embodiments, the shadow management system 102 may receive the base address element as signed via the authentication system (e.g., signed by a signing authority through the authentication system).

The shadow management system 102 may generate a shadow address associated with the first communication retrieval request based on the base address element and address construction element set. For example, as depicted in shadow addresses 460, the shadow management system 102 may apply the base address element and address construction element set to a hash function, or multiple iterations of one or more hash functions, to generate the corresponding shadow address “QZ8.” For example, the shadow management system may concatenate each address construction element to generate a combined address construction element, and combine the base address element with the combined address construction element for hashing via the hash function.

In some embodiments, the first communication retrieval request comprises, is embodied by, or otherwise is associated with, a specially configured command communication. In this regard, the shadow management system 102 may initiate retrieval of a communication set in response to receiving the command communication. In some examples, the first communication retrieval request is embodied by a command communication that contains communication contents representing the address construction element set and/or base address element. In some embodiments, the shadow management system 102 may identify the command communication as such using one or more indicators. For example, the shadow management system 102 may identify that the command communication does not include a recipient shadow address, indicating it is a command communication. Alternatively, the command communication may include a flag, bit indicator, or the like that indicates the communication is a command communication, and/or specifically indicating the command communication is a communication retrieval request.

At step 410, the shadow management system retrieves the communications stored associated with the generated shadow address associated with the first communication retrieval request. For example, the communications may be retrieved from communication queue 450 based on the shadow address “QZ8.” In some embodiments, the communications may be retrieved by querying the database, repository, queue, blockchain, or the like, for communications including, or otherwise associated with, a recipient shadow address, for example the shadow address “QZ8.” In response to the query, the communications associated with the recipient shadow address may be returned as result data. For example, as depicted, the first communication is retrieved, as it includes or is otherwise associated with the recipient shadow address “QZ8.” The communications including, or otherwise associated with, a different recipient shadow address. For example, the second communication and third communication are not retrieved.

A first communication retrieval response may be transmitted in response to the first communication retrieval request. The first communication retrieval response may include retrieved communications, or portions thereof, and associated and/or stored information, metadata, and the like. For example, the shadow management system 102 may be configured to transmit, to the client device associated with the communication retrieval request (for example, Alice's device 104C), a communications set including zero or more communications retrieved based on the communication retrieval request. The communication retrieval response may include the communications set, including and/or associated with a sender shadow address and/or a recipient shadow address.

Upon receiving the communication(s), the client device may perform any number of a myriad of operations. In some embodiments, one or more of the communications may be rendered to an interface provided by client device. For example, the first communication may be rendered to an interface of Alice's device 104C for viewing by a corresponding user and/or to receive interaction by a corresponding user.

In some embodiments, the client device may be configured to enable response to a received communication. For example, if desired after step 410, the user associated with Alice's device 104C may engage one or more interfaces rendered to Alice's device 104C to reply to the message received from Bob's device 104A. In example circumstances where the retrieved communication is a group communication (e.g., sent to shadow address “QZ8” as well as one or more other shadow addresses), the user may select from the sender shadow address and other recipient shadow addresses to whom they want to transmit a reply communication. For example, the user may generate and transmit a reply communication to just the sender shadow address (e.g., “B25”), a single other recipient shadow address, one or more other recipient shadow addresses, or the sender shadow address and one or more other recipient shadow addresses (including the full group).

At step 412, Alice's device 104C transmits a second communication retrieval request to the shadow management system 102. The communication retrieval request may represent a desire to retrieve the communications associated with a particular shadow address (or shadow address set). The communications retrieval request may include, or otherwise be associated with, a particular shadow address. The communication retrieval request may include, or otherwise be associated with a particular shadow address for which corresponding communications are to be retrieved. The For example, the second communication retrieval request may be associated with the base address clement of “123” for Alice's device 104C, and the address construction element set comprising a single address construction element—specifically the string “Public.” The address construction element “Public” may be a unique personal identifier input by a user associated with Alice's device 104C.

The base address element associated with the second communication retrieval request may similarly be identified, received, or otherwise retrieved via a header enrichment process. For example, the base address may be a mobile phone number associated with Alice's device 104C, which may be identified, received, or otherwise retrieved via the header enrichment process, or another verification process. In other embodiments, a DAA, header enrichment, or other verification process may be executed by an authentication system configured to communicate with Alice's device 104C. In some such embodiments, the shadow management system 102 may receive the base address element signed via the authentication system. For example, the signed base address element may be received as part of, or along with, the communication retrieval request.

The shadow management system 102 may similarly generate a shadow address associated with the second communication retrieval request based on the second base address element and the second address construction element set. For example, as depicted in the shadow addresses 460, the shadow management system may apply the base address element “123” and the address construction element set “Public” to a hash function, or multiple iterations of one or more hash functions, to generate the corresponding shadow address “RS8.” For example, the shadow management system may concatenate each address construction element to generate a combined address construction element, and combine the base address element with the combined address construction element for hashing via the hash function. In other embodiments, another one-way transformation, or multiple iterations of one or more one-way transformations, may be used.

At step 414, the shadow management system 102 retrieves the communications stored associated with the generated shadow address associated with the first communication retrieval request. For example, the communications may be retrieved from the communications queue 450, now based on the shadow address “RS8” associated with the second communication retrieval request. In some embodiments, the communications may be retrieved by querying a database, repository, queue, blockchain, or the like, for communications including, or otherwise associated with, the recipient shadow address, for example “RS8.” In response to the query, the communications associated with the recipient shadow address may be returned as result data. For example, as depicted, the second communication (“Call Carol”/“M7R”) and third communication (“My Private Address”/“CCN”) are retrieved from the communications queue 450, as both include or are otherwise associated with the recipient shadow address of “RS8.” Although not depicted, any other communications associated with other recipient shadow addresses would not be retrieved.

The shadow management system 102 may transmit a second communication retrieval response to Alice's device 104C in response to the second communication retrieval request. The second communication retrieval request may include the retrieved communications, or portions thereof, and associated and/or stored information, metadata, and the like associated with each of the retrieved communications. For example, the shadow management system 102C may be configured to transmit, to the client device associated with the communication retrieval request (for example, Alice's device 104C), a communications set including zero or more communications retrieved based on the communication retrieval request. For example, the second communication retrieval response may include the retrieved communications including, or associated with, the sender shadow address and/or recipient shadow address for each communication.

Upon receiving the communication(s), the client device may perform any number of a myriad of operations. In some embodiments, one or more of the communications may be rendered to an interface provided by the client device, such as Alice's device 104C. For example, the second communication and the third communication may be rendered to an interface of Alice's device 104C for viewing by a user of Alice's device 104C and/or to receive interaction from the user. In some embodiments, an interface may be updated to include the newly retrieved communications as well as prior retrieved communications (e.g., the first communication). In some such embodiments, the interface may designate the recipient shadow address associated with each retrieved communication.

In some embodiments, communications are stored only for a certain expiration period. For example, in some embodiments an expiration period may be a fixed timestamp interval (e.g., X minutes, X hours, X days, or the like, where X is a number). In some embodiments, the expiration period applies to all communications. In some such embodiments, each communication may be stored associated with a communication received timestamp, where the shadow management system 102 is configured to delete, archive, or otherwise make inaccessible the corresponding communication after the expiration period lapses based on the communication received timestamp. In some embodiments, the shadow management system 102 may perform one or more checks to determine whether one or more communications have been stored past the expiration period, which may be performed at a predefined interval (e.g., hourly, daily, or the like) or in real-time.

In some embodiments, the shadow management system 102 may apply one expiration period to all communications. For example, a predetermined expiration period may be applied to each communication. In other embodiments, the shadow management system 102 may determine an expiration period associated with a communication based on the communication, or one or more fields therein. For example, in some embodiments, the expiration period may be determined based on the sender recipient address, communication type, communication contents, or the like. Alternatively, in other embodiments, the expiration period may be determined at a shadow account level. For example, in some embodiments, the user associated with a shadow address may configure a shadow address such that communications received by the shadow address (e.g., communications where the shadow address is listed as a recipient shadow address) are stored for a certain expiration period. In this regard, a user may configure each shadow address to be associated with a different expiration period should they desire to do so.

The data flow illustrated in FIG. 4 may continue for subsequent transmission and retrieval of communications. For example, one or more communications may be generated and/or transmitted by one of the client devices 104A-104C to one of the other client devices 104A-104C. Such communications may similarly be received, stored, and transmitted by the shadow management system 102 as described above.

It should be appreciated that the above system may utilize one of a myriad of base address types. For example, in some embodiments, the base addresses may embody a mobile phone number, and in other embodiments, the base address may embody an email address, username, or the like. Additionally, it should be appreciated that the apparatuses, devices, sub-systems, or other components of the system may communicate via various architectures and/or protocols. For example, in some embodiments, the system may utilize the telephony network and/or corresponding telephony protocols. In some embodiments, the system may utilize Voice Over Internet Protocol (VOIP), Ethernet, Transmission Control Protocol/Internet Protocol (TCP/IP), User Datagram Protocol (UDP), Short Message Service (SMS), cable communications, or another communication protocols as the medium by which components of the above system communicate, regardless of whether they are streaming or non-streaming.

### Example Operations for Performance by Embodiments

Having described an example data flow, specific example flowcharts including various operations performed by apparatuses, devices, and/or sub-systems of the above described systems will now be discussed. It should be appreciated that each of the flowcharts depicts an example computer-implemented process that may be performed by one, or more, of the above described apparatuses, systems, or devices. In regard to the below flowcharts, one or more of the depicted blocks may be optional in some, or all, embodiments. Optional blocks are depicted with broken (dashed) lines.

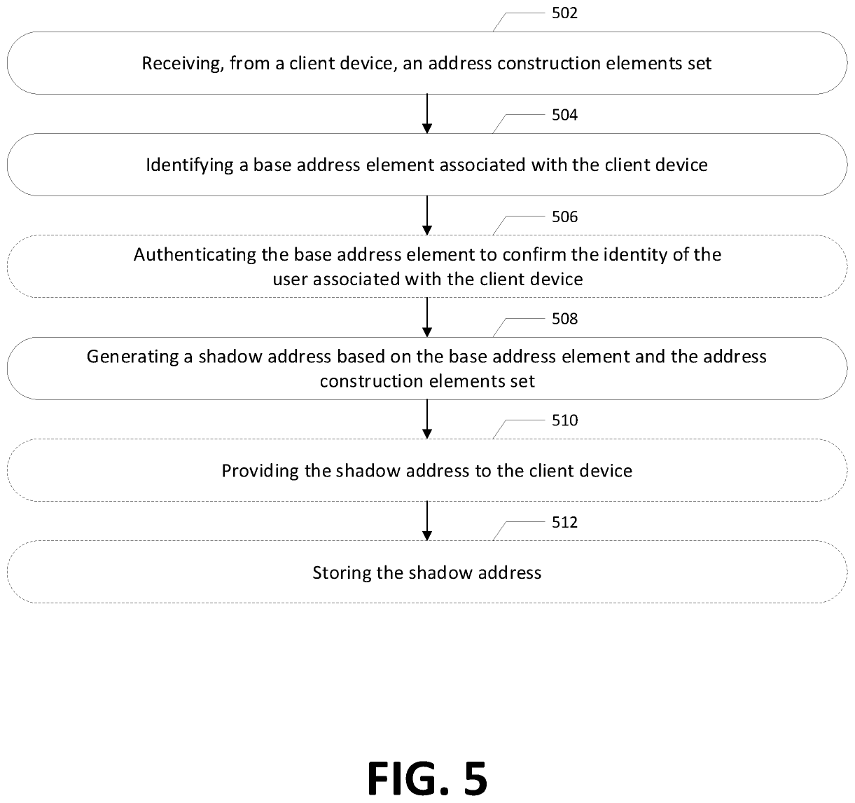

It should be appreciated that the particular operations depicted and described below with respect to FIGS. 5-8 illustrate specific operations or steps that may be performed in a particular process. Further, the process may be implemented by computer hardware, software, or a combination thereof, of a system, apparatus, device, or the like, as a computer-implemented method. In other embodiments, the various blocks may represent blocks capable of being performed by an apparatus, device, or system. For example, computer-coded instructions may be specially programmed for performing the various operations depicted and stored for execution by an apparatus, for example in one or more memory devices for execution by one or more processors. In other embodiments, computer program code capable of executing the operations depicted by the various blocks may be stored to one or more non-transitory memory devices associated with a computer program product or other computer readable storage medium.

FIG. 5 illustrates an example process for generating a shadow address, in accordance with an example embodiment of the present disclosure. The example process illustrated may be performed by a shadow management system, for example a shadow management system embodied by apparatus 200. In some embodiments, the apparatus 200 may be configured to communicate with one or more devices, systems, apparatuses, or the like for receiving and/or transmitting the information described with respect to the example process.

At block 502, the apparatus 200 includes means, such as authorization module 210, shadow address management module 212, communications module 208, input/output module 206, processor 202, and/or the like, or a combination thereof, for receiving, from a client device, an address construction element set. In some embodiments, the address construction element set may be received as part of shadow address generation request. The apparatus 200 may receive the address construction element set form the client device over one network or a plurality of networks.

The address construction element set, as described, may include one or more of address construction elements. For example, the address construction elements may include a representation of a random value (for example, a string or another value, which may include an empty string or a null string), a timestamp, a user input nickname, a user input category or label, a file, a public key, a private key, a geolocation, a third-party base address element, or a hash or other one-way transformation of any thereof, or a combination thereof. One or more of the address construction elements provided in the address construction element set may be automatically parsed and/or extracted from the client device. For example, the user input category or label may represent a text description inputted and stored by a user of the client device (for example “Bob” or “Bob from school”), which the client device may have retrieved automatically for transmission, for example along with a shadow address generation request.

At block 504, the apparatus 200 includes means, such as authorization module 210, shadow address management module 212, communications module 208, input/output module 206, processor 202, and/or the like, or a combination thereof, for identifying a base address element associated with the client device. In some embodiments, the base address element is received from the client device. For example, the base address element may be received as part of a shadow address generation request, for example along with the address construction element set.

In some such embodiments, the client device may not be associated with the base address element. For example, in an example embodiment, a client device may provide one or more interfaces for generating a shadow address. One or more of the interfaces may include one or more interface elements for inputting a base address element and/or address construction element set. The user may, for example, input a base address element associated with a second client device controlled by the user, such as when the user is utilizing the client device of another user to generate the shadow address. In a particular example where a base address element represents a mobile device number, for example, a first user may use a second user's mobile device to generate a shadow address, but the first user may input their mobile device number, in string form or other form, as a base address element. In this regard, the resulting generated shadow address may be accessible only by the client device associated with the base address element despite being generated via the second client device associated with the second user.

In some embodiments, the base address element is identified, for example from the client device, indirectly through a DAA process. For example, the base address element may be identified using a header enrichment process, wherein the base address element is identified via a carrier network. The carrier network may comprise a carrier device included in or communicable with the apparatus 200. In this regard, the apparatus 200 may, via the carrier device, utilize a secure process for identifying the base address element, for example SIM technology or other technology utilized to identify an identifier for billing a mobile device account, to be confident that the base address element is associated with the client device. The carrier device of the carrier network may be configured to perform the header enrichment process.

The base address element may represent any one of a myriad of types of base address. For example, in some embodiments, a base address may be a mobile phone number, email address, login address, a unique identifier, or the like. In some embodiments, a base address element may be of a string type, such that the base address is represented by a corresponding base address string. In other embodiments, other types may be used to represent a base address as a base address element.

At optional block 506, the apparatus 200 includes means, such as authorization module 210, shadow address management module 212, communications module 208, input/output module 206, processor 202, and/or the like, or a combination thereof, for identifying or otherwise authenticating the base address element to confirm the identity of the user associated with the client device. In this regard, the base address may be associated with one or more authentication processes such that if a user has access to the base address (for example, access via a mobile device or a specific account via the mobile device), that access confirms the user's identity. In some embodiments, a base address element is authenticated automatically based on the process utilized to identify the base address element. For example, a base address element may be automatically authenticated where a header enrichment process is utilized to identify the base address element. In other embodiments, the authentication process may utilize a standard login process, for example by authenticating a username and password combination. In some such embodiments, the username, password, or a combination thereof, may form the base address, or other account information associated with the username and password, such as an account identifier, may form the base address. Alternatively or additionally, some embodiments may employ a non-DAA authentication process, such as an OAuth authentication process, a remote authentication dial-in user service process, a login authentication process or other authentication process.

In other embodiments, the base address element may be received associated with, signed with, or including authentication information. The authentication information may identify that the base address element has been authenticated as associated with the client device by an authentication server. For example, in some embodiments, the base address element may be signed by a signing authority, and the signed base address element may be provided by the client device, such as included in, or along with, a shadow address generation request. The base address element may be authenticated or verified using one or more address construction elements provided in the address construction element set (e.g., a public key associated with the client device or the shadow address). In other embodiments, the apparatus 200 may be configured to perform one or more login processes to authenticate the base address element.

At block 508, the apparatus 200 includes means, such as shadow address management module 212, processor 202, and/or the like, or a combination thereof, for generating a shadow address based on the base address element and the address construction element set. The shadow address may be generated by applying a combined address element to a one-way transformation. The combined address element, similarly, may be generated using one or more element transformation processes, or multiple iterations of one or more element transformation processes. For example, in some embodiments, the apparatus 200 may apply the base address element and each address construction element of the address construction element set to one or more element transformation process to generate a combined address element. In other embodiments, the apparatus 200 may apply the base address element and/or address construction element set to generate one or more intermediate elements that may then be applied to one or more element transformation processes for generating the shadow address. For example, in some embodiments, an intermediate element may be generated by applying a combination of the base address element and/or a combination of some or all of the address construction elements to one or more element transformation process(es). For example, in some embodiments, the apparatus 200 may generate an intermediate element based on one or more of the address construction elements, for example by applying the address construction elements to an element transformation process that concatenates the address construction elements. The apparatus 200 may then apply the intermediate element and base address element to a one-way transformation function, such as a hash function, mathematical transformation, or the like, to generate the corresponding shadow address. Yet in other embodiments, the apparatus 200 may apply an intermediate element representing the concatenation of the address construction elements and a base address element to another element transformation process that concatenates the intermediate element and the base address element to generate a second intermediate element for use in generating the shadow address. In some such embodiments, the apparatus 200 may then apply the second intermediate element to a one-way transformation function, such as a hash function, mathematical transformation, or the like, to generate the corresponding shadow address. In this regard, it should be appreciated that the base address element, address construction element set or any portion thereof, or one or more intermediate elements, or any combination thereof, may be applied to one or more element transformation processes, or one or more iterations thereof, before being used to generate a corresponding shadow address.

An element transformation process may embody one or more algorithms, formulas, or other processes for combining and/or transforming two or more address elements. For example, in some embodiments where each address construction element is a string type, a combined address construction element representing an intermediate address may be formed using an element combination process for concatenating some or all of the address construction elements in the address construction element set. In some embodiments, each address construction element may be separated by a reserved separator character. In some embodiments, the combined address construction element may represent the concatenation of all address construction elements, and any separator characters if required.

The apparatus 200 may generate a second intermediate element for use in generating a corresponding shadow address based on the base address element and the intermediate element. For example, in some embodiments, the second may be generated by concatenating the base address element with the first intermediate element. In other embodiments, the base address element and first intermediate element may be applied to one or more other element transformation processes to generate the resulting second intermediate element for use in generating the shadow address.

In some embodiments, any number or combination of element transformation processes may be used. For example, in some embodiments, an element transformation process may embody a bitwise transformation of the base address element and/or address construction element set (e.g., an XOR, AND, OR, complex bitwise transformation, or other bitwise transformation). Alternatively or additionally, in some embodiments, an element transformation process embodies a mathematical function or a combination of mathematical functions. In some embodiments, an element transformation process may convert a base address element and/or one or more address construction elements to perform one or more subsequent transformations. In a particular example having a base address element and a single address construction element, the element may be converted into a number and used in one or more mathematical algorithms, for example:

Intermediate_address=(converted_address_construction_element)*(converted_base_address_element)+(converted_base_address_element)\hat{ }3−3*(converted_address_construction_element)

This algorithm may similarly be expanded for multiple address construction elements. It should be appreciated that any number and any types of element transformation processes may be utilized to generate a final intermediate element that may be applied to a one-way transformation. Alternatively, in some embodiments, the apparatus 200 may apply the base address element and/or address construction element set to a one-way transformation without use of any element transformation process(es)

The apparatus 200 may generate the shadow address using one or more one-way transformations, algorithms, hash functions, or the like. In some embodiments, the base address element and the address construction element set may be applied to a hash function, or another one-way transformation, to generate the shadow address. For example, in some embodiments, the shadow address is generated by applying the combined address element to one or more hash functions. In other embodiments, the hash function may generate the shadow address based on the base address element and the combined address construction element, or the base address element and the address construction element set. In some embodiments, the apparatus 200 may be configured to utilize a predetermined one-way function, such as a predetermined hash function. In other embodiments, the apparatus 200 may determine the one-way transformation or hash function to utilize based on one or more parameters, for example the hash function may be determined based on the communication type, the sender shadow address, the recipient shadow address, or one or more of the address construction elements.

In some embodiments, the shadow address is generated by applying the one-way transformation or hash function once. In other embodiments, multiple iterations of the one-way transformation or hash function, or multiple iterations of a plurality of one-way transformations or hash functions, may be utilized. For example, the hashed elements may be hashed twice or more in some embodiments, and/or utilize additional information (e.g., different address construction elements) for each iteration of hashing. In some embodiments, multiple hash functions may be utilized to perform multiple iterations of hashing. For example, in some embodiments, a first hash function may be utilized, then a second hash function. Alternatively, a first hash function may be utilized twice, or a first hash function may be utilized twice, then a second hash function utilized once or more.

The one-way transformation(s), for example hash function(s), may be configured to generate a shadow address in a predetermined format. In some embodiments, the format of the shadow address may be based on the base address represented by the base address element. For example, in embodiments where the base address is a mobile phone number, the shadow address may be generated in a predetermined phone number format associated with the base address (e.g., 7 digits or 10 digits). In embodiments where the base address is an email, the shadow address may be generated in a predetermined alphanumeric format having a maximum length in email format (e.g., having a maximum amount of characters including an @ separator). In some embodiments, the shadow address may include an identifier indicating the address is a shadow address. In other embodiments, a base address may embody another identifier, username, login, or the like, and the corresponding shadow address may be generated in any of a myriad of alphanumeric, numeric, or other formats.

For example, in some embodiments, an address service identifier may be appended or otherwise associated with a created shadow address. In an example embodiment, for example where a base address element comprises an email address string, the shadow address may comprise the output of a one-way function, such as a hash function, appended address service identifier embodying the domain associated with the email address string. For example, where “alice@email.com” is hashed with “bob” to generate “xgb,” the domain portion of the base address element may be appended to the output of the hash to generate a final shadow address of “xgb@email.com.” In some such embodiments, the apparatus 200 may communicate with one or more third-party communications servers to enable transmission of communications to such shadow addresses, or retrieval of communications associated with such shadow addresses.

Alternatively or additionally, in some embodiments, the apparatus 200 may append a prefix or suffix to the output of the one-way function to generate the final shadow address. For example, where “alice@email.com” is hashed with “bob” to generate “xgb” (e.g., H{“alice@email.com”+“bob”} =“xgb” the apparatus may append a prefix of “shadow_address.” to form the shadow address “shadow_address.xgb.” The shadow address may then be used as a recipient shadow address to transmit communications to the user controlling the client device associated with or configured to access the base account, without communication or utilization of any third-party communications system.

In some such embodiments, the apparatus 200 may transmit communications to the generated shadow address utilizing an existing third-party communication system or interface. For example, the apparatus 200 may communicate with a third-party email service provider system to transmit and/or retrieve communications for transmission to or from a client device. Alternatively or additionally, the apparatus 200 may communication with a third-party text messaging system, carrier system, chat application system, or the like. In some embodiments, the apparatus 200 may facilitate communication between client devices associated with each shadow addresses via the apparatus 200 indirectly or through peer-to-peer communications between the client devices connected via the apparatus 200. In other embodiments, the apparatus 200 may implement or otherwise facilitate transmission and reception of communications using a custom communications protocol executed via the apparatus 200. For example, in some such embodiments, a recipient shadow address may include a prefix and/or suffix, for example “shadow_address.”, which may be identified by the apparatus 200 to indicate that the communication should be transmitted via the custom communication protocol as opposed to via a third-party communication system.

At optional block 510, the apparatus 200 includes means, such as shadow address management module 212, communications module 208, processor 202, and/or the like, or a combination thereof, for providing the shadow address to the client device. In some embodiments, the apparatus 200 generates and/or transmits a shadow address generation response comprising the shadow address. For example, the client device may be identified based on information and/or metadata provided at an earlier block, for example, based on a received shadow address generation request.

In some embodiments, the apparatus 200 provides the shadow address in a human-readable format, for example a text format. In other embodiments, the apparatus 200 may generate an encoded shadow address based on the shadow address, and provide the encoded shadow address to the client device. For example, in some embodiments, the apparatus 200 may generate an encoded shadow address that is decodable by the client device, or by another client device that the client device shares the encoded shadow address with. For example, the encoded shadow address may be embodied by a binary (or other base) number, an encoded text string, or the like, or a combination thereof.

In other embodiments, the encoded shadow address may be embodied by a shadow address scannable representation. The shadow address scannable representation may be configured to be scanned and/or otherwise decoded by the client device, or another client device. For example, the shadow address scannable representation may be embodied, without limitation, by a QR code, a bar code, a decodable image, or the like. In some embodiments, the shadow address scannable representation may be configured detected and/or decoded by a second client device (e.g., via a mobile device having or associated with a camera) configured to detect the shadow address scannable representation and decode the corresponding shadow address in order to facilitate sharing of the shadow address scannable representation.

In some embodiments, by providing the shadow address to the client device, the apparatus 200 may cause the client device to render, or otherwise display, the shadow address. For example, the shadow address may be provided, and subsequently rendered or otherwise displayed, as is, as an encoded representation, and/or as a shadow address scannable representation. Additionally or alternatively, the rendered shadow address may be shareable, in person or via the client device, with one or more other client devices. For example, the apparatus 200 may cause the client device to share the shadow address with one or more contacts stored by the client device.

In some embodiments, by providing the shadow address to the client device, the apparatus 200 may cause the client device to store the shadow address, and/or the associated base address element and/or address construction element set. The apparatus 200 may cause the client device to store the shadow address, the base address element, and/or the address construction element set associated with an identifier or other information for re-accessing the shadow address, for example to re-generate and utilize the shadow address at a future time. In some embodiments, the client device may enable a user to retrieve the stored shadow address, and/or the base address element and/or the address construction element set for transmitting to the apparatus 200.

At optional block 512, the apparatus 200 includes means, such as shadow address management module 212, memory 204, processor 202, and/or the like, or a combination thereof, for storing the shadow address. In some embodiments, the apparatus 200 may store the shadow address associated with the base address element. Additionally or alternatively, in some embodiments, the shadow address may be stored associated with a client device identifier. The shadow address may be stored in a database, repository, blockchain storage, or the like. In some embodiments, the shadow address may be stored in a sub-database, table, or the like.

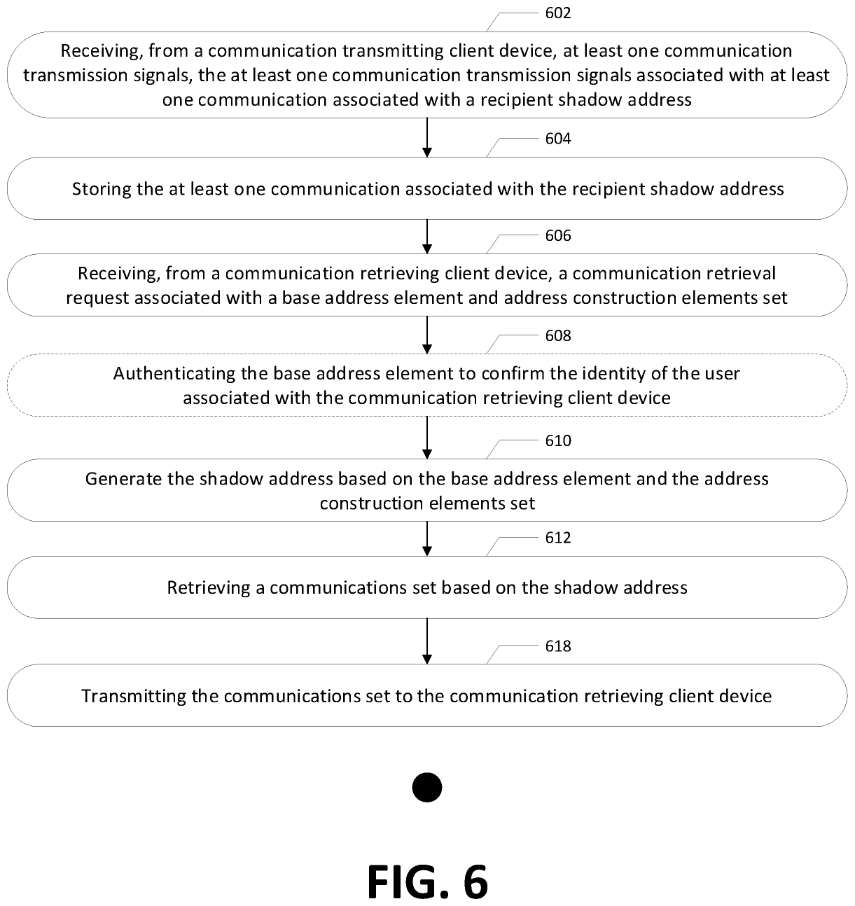

FIG. 6 illustrates an example process for transmitting and receiving communications utilizing a shadow address. Transmitting and receiving communications may embody an example process, or embody a portion of an example process, for managing and utilizing a shadow address in accordance with an example embodiment of the present disclosure. The example process illustrated may be performed by a shadow management system, for example a shadow management system embodied by apparatus 200. In some embodiments, the apparatus 200 may be configured to communicate with one or more devices, systems, apparatuses, or the like for receiving and/or transmitting the information described with respect to the example process.

At block 602, the apparatus 200 includes means, such as shadow address management module 212, shadow transmission management module 214, communications module 208, processor 202, and/or the like, or a combination thereof, for receiving, from a communication transmitting client device, at least one communication transmission signals, the at least one communication transmission signals associated with at least one communication associated with a recipient shadow address. The communication transmitting client device may be one of many client devices configured to communicate with the apparatus 200. In some embodiments, the apparatus 200 may be communicable with any number of client devices. Each client device may be configured to communicate with the apparatus 200 over one or more networks. For example, one or more client devices may be configured to communicate with the apparatus 200 over a carrier network, for example a mobile network controlled by a mobile carrier. Additionally or alternatively, the client device may be configured to communicate with the apparatus 200 over one or more other networks, including a Wi-Fi network, LAN, WLAN, PAN, or the like.

In some embodiments, a single communication transmission signal is associated with a single communication. The single communication transmission signal may include electronic data embodying the communication and/or associated information and/or metadata. For example, each communication transmission signal may include a sender device identifier that uniquely identifies the communication transmitting client device (e.g., an IP address, IMEI, serial number, or the like). Additionally or alternatively, each communication transmission signal may include a signal transmission timestamp, or a communication sent timestamp, that represents the time the communication was transmitted from the communication transmitting client device. In some embodiments, multiple communication transmission signals may be received associated with multiple communications. In other embodiments, one communication transmission signal may be associated with a plurality of communications. For example, communications transmitted by the user over a short period of time may be batched and provided using a single communication transmission signal that includes information identifying the various transmitted communications.

The recipient shadow address may represent a shadow address who the sender intends to provide the communication. In some embodiments, the recipient shadow address may be parsed and/or identified from the communication. For example, in some embodiments, the communication includes at least a recipient field identifying the recipient shadow address. In some embodiments, the user of the communication transmitting client device may select the recipient shadow address from a stored shadow address list. For example, the user may store one or more recipient shadow addresses in a contacts management software, for example an address book, to select for communicating with the recipient shadow addresses. In some embodiments, communication transmitting client device may be configured to receive the recipient shadow address via user input. The user input may include a manually input shadow address, or a scannable shadow address and/or encoded shadow address that was scanned and/or decoded by the user via the communication transmitting client device.

In some embodiments, the communication transmission signal(s) includes or is/are associated with information for identifying and/or generating a sender shadow address associated with the at least one communication. For example, in some embodiments, the communication transmission signal(s) may include a base address element and/or address construction element set for use in generating a sender shadow address. Alternatively or additionally, in some embodiments, the apparatus 200 may identify a base address element associated with the communication transmitting client device. For example, the apparatus 200 may perform a header enrichment process to identify and/or authenticate the base address element associated with the communication transmitting client device.

The apparatus 200 may, in some embodiments, further include means to verify the received communication(s) satisfy corresponding shadow address restriction settings. For example, as described above, the apparatus 200 may, for each communication, identify a shadow address restriction settings set associated with the communication. The apparatus 200 may then confirm that the communication satisfies each restriction setting in the shadow address restriction settings set. The communication may be rejected if it does not satisfy all, or a defined subset, of the shadow address restriction settings set. In some such embodiments, an error signal may be generated and/or transmitted to the communication transmitting client device that includes a message regarding the rejected communications.

At block 604, the apparatus 200 includes means, such as authorization module 210, shadow address management module 212, shadow transmission management module 214, processor 202, and/or the like, or a combination thereof, for storing the at least one communication associated with the recipient shadow address. The at least one communication may be stored in a database, repository, blockchain storage, or the like, or a combination thereof, or a sub-database or table of a database. Additionally or alternatively, the apparatus 200 may store the communication(s) associated with the sender shadow address, for example a generated or received sender shadow address as described. In some embodiments, the communication may be updated to include the sender shadow address in a sender field. Alternatively or additionally, the apparatus 200 may store the communication in a communication record that includes at least the sender shadow address and the communication.

It should be appreciated that the communications may be stored in any number of ways, and organized in any number of ways. For example, the communications may be stored alphabetically by communication contents, sender shadow address, recipient shadow address, or the like. Alternatively, the communications may be stored based on metadata associated with each communication. For example, the communications may be stored based on a received timestamp, communication size, or any other metadata field.

The apparatus 200 may store received communications such that the received communications are retrievable based on the recipient shadow address. For example, the communications may be stored in a communication queue based on the recipient shadow address. For example, the communication queue may be embodied by a blockchain storage configured for storing the communications in one or more blockchains based on the sender shadow address, the recipient shadow address, or a combination thereof. It should be appreciated that the blockchain storage(s) may store the communications permanently, or temporarily. For example, each communication may be stored associated with a particular expiration period, such that the apparatus 200 is configured to delete, remove, or otherwise make the communication inaccessible after the expiration period elapses.

At block 606, the apparatus 200 includes means, such as shadow address management module 212, shadow transmission management module 214, communications module 208, processor 202, and/or the like, for receiving, from a communication retrieving client device, a communication retrieval request associated with a base address element and address construction element set. In some embodiments, the communication retrieval request may include the base address element and/or address construction element set. For example, the base address element and/or address constructions elements set may be extracted and/or parsed from the communication retrieving client device. The communication retrieving client device may store some or all of the address construction element set, for example stored via contacts management software executed on the communication retrieving client device, which may be retrieved and transmitted for retrieving communications associated with a corresponding shadow address.

In some embodiments, the communication retrieval request comprises, is embodied by, or otherwise is associated with, a specially configured command communication. In this regard, the apparatus 200 may initiate one or more actions for retrieval of a communication set in response to receiving the command communication. In some examples, the communication retrieval request is embodied by a command communication that contains communication contents representing the address construction element set and/or base address element. In some embodiments, the apparatus 200 may identify the command communication as such using one or more indicators. For example, the apparatus 200 may identify that the command communication does not include a recipient shadow address, indicating it is a command communication. Alternatively, the command communication may include a flag, bit indicator, or the like that indicates the communication is a command communication, and/or specifically indicating the command communication is a communication retrieval request.

In some embodiments, the apparatus 200 is configured to identify the base address element associated with the communication retrieval request. For example, the apparatus 200 may perform one or more verification processes to identify the base address element. In some such embodiments, the apparatus 200 is configured to perform a header enrichment process to identify and/or authenticate the base address element. For example, in some embodiments, the apparatus 200 may, via an associated a client network comprising a client device, identify a base address element that represents the mobile phone number associated with the client device.

Alternatively or additionally, in some embodiments, the received base address element and address construction element set includes inputs from the user via the communication retrieving client device. For example, the user of the communication retrieving client device may, via user engagement with one or more interfaces rendered to the communication retrieving client device, input the received base address element and/or address construction element set for transmission. Thus, the base address element and address construction element set may serve as private information for authenticating the shadow address is associated with the user of the client device. Data security may be further enhanced by identifying and/or authenticating the base address element.

At optional block 608, the apparatus 200 includes means, such as authorization module 210, shadow address management module 212, communications module 208, input/output module 206, processor 202, and/or the like, or a combination thereof, for identifying or otherwise authenticating the base address element to confirm the identity of the user associated with the communication retrieving client device. In this regard, the apparatus 200 may ensure that the communication retrieving client device is associated with the base address element that may be used to generate the shadow address, such as by confirming a user has access to the base address (for example, access via a mobile device or a specific account via the mobile device), such that access to the base address confirms the user's identity. In some embodiments, a base address element is authenticated automatically based on the verification process utilized to identify the base address element. For example, a base address element may be automatically authenticated when utilizing a header enrichment process to identify the base address element. In other embodiments, the authentication process may utilize a standard login process, for example by authenticating a username and password combination. In some such embodiments, the username, password, or a combination thereof, may form the base address, or other account information associated with the username and password, such as an account identifier, may form the base address. Alternatively or additionally, some embodiments may employ a non-DAA authentication process, such as an OAuth authentication process, a remote authentication dial-in user service process, a login authentication process or other authentication process.

In other embodiments, the base address element may be received associated with, signed with, or including, authentication information. The authentication information may identify that the base address element has been authenticated as associated with the client device by an authentication server. For example, in some embodiments, the base address element may be signed by a signing authority, and the signed base address element may be provided by the client device, such as included in, or along with, a shadow address generation request. The base address element may be authenticated or verified using one or more address construction elements provided in the address construction element set (e.g., a public key associated with the client device or the shadow address). In other embodiments, the apparatus 200 may be configured to perform one or more login processes to authenticate the base address element.

At block 610, the apparatus 200 includes means, such as shadow address management module 212, processor 202, and/or the like, or a combination thereof, for generating a shadow address based on the base address element and the address construction element set. The generated shadow address may, in this regard, be associated with the communication retrieving client device. The shadow address may be generated based on a combined address element that includes a combination of the base address element and a combination of some or all of the address construction elements. For example, in some embodiments, the apparatus 200 may generate a combined address construction element based on one or more of the address construction elements. For example, each address construction element may be a string type, such that the combined address construction element may be formed by concatenating some or all of the address construction elements in the address construction element set. In some embodiments, each address construction element may be separated by a reserved separator character. In some embodiments, the combined address construction element may represent the concatenation of all address construction elements, and any separator characters if required. In other embodiments, it should be appreciated that one or more other algorithms may be utilized to generate a combined address construction element. For example, in some embodiments the address construction element set may be applied to one or more mathematical transformation algorithms and/or hash functions.

The apparatus 200 may generate a combined address element based on the base address element and the combined address construction element. For example, in some embodiments, the combined address element may be generated by concatenating the base address element with the combined address construction element. In other embodiments, the base address element and combined address construction element may be applied to one or more functions, algorithms, or the like to generate the resulting combined address element.

The apparatus 200 may generate the shadow address using one or more hash functions or other one-way transformations. In some embodiments, the base address element and the address construction element set may be applied to a hash function to generate the shadow address. For example, in some embodiments, the shadow address is generated by applying the combined address element to one or more hash functions. In other embodiments, the hash function may generate the shadow address based on the base address element and the combined address construction element, or the base address element and the address construction element set. In some embodiments, the apparatus 200 may be configured to utilize a predetermined hash function. In other embodiments, the apparatus 200 may determine the hash function to utilize based on one or more parameters, for example the hash function may be determined based on the communication type, the sender shadow address, the recipient shadow address, or one or more values of the address construction elements.

In some embodiments, the shadow address is generated by applying the hash function once. In other embodiments, multiple iterations of the hash function may be utilized. For example, the hashed elements may be hashed twice or more in some embodiments, and/or utilize additional information (e.g., different address construction elements) for each iteration of hashing. In some embodiments, multiple hash functions may be utilized to perform multiple iterations of hashing. For example, in some embodiments, a first hash function may be utilized, then a second hash function. Alternatively, a first hash function may be utilized twice, or a first hash function may be utilized twice, then a second hash function utilized once or more.

The hash function(s) may be configured to generate a shadow address in a predetermined format. In some embodiments, the format of the shadow address may be based on the base address represented by the base address element. For example, in embodiments where the base address is a mobile phone number, the shadow address may be generated in a predetermined phone number format (e.g., 7 digits or 10 digits). In embodiments where the base address is an email, the shadow address may be generated in a predetermined alphanumeric format having a maximum length in email format (e.g., having a maximum amount of characters including an @ separator). In other embodiments, a base address may embody another identifier, username, login, or the like, and the corresponding shadow address may be generated in any of a myriad of alphanumeric, numeric, or other formats.

At block 612, the apparatus 200 includes means, such as shadow address management module 212, shadow transmission management module 214, processor 202, memory 204, and/or the like, or a combination thereof, for retrieving a communication set based on the shadow address. In some embodiments, the apparatus 200 queries one or more databases, repositories, blockchain storages, or the like, based on the generated shadow address. For example, the apparatus may query for communications including or associated with the generated shadow address as recipient shadow address. The apparatus 200 may receive the communication set in response to the query (or multiple queries). The communication set may include all communications stored associated with the generated shadow address as recipient shadow address. In some embodiments, the communication set may be retrieved from a communication queue based on the generated shadow address. For example, the apparatus 200 may maintain one or more communication queue, each storing communications associated with a particular recipient shadow address.

In some embodiments, the retrieved communication set includes no stored communications (e.g., the retrieved communication set is empty). For example, the communication set may be empty when no communications have been transmitted that indicate the shadow address as a recipient shadow address. Similarly, the communication set may be empty when no communications have been transmitted to the shadow address since the previous time a user retrieved communications associated with the shadow address. In some such embodiments, the empty communication set may be transmitted back to the communication retrieving client device. Alternatively, in some embodiments, the apparatus 200 may generate a response message that indicates no communications have been retrieved.

In some embodiments, the apparatus 200 is configured to store communications based on an expiration period. In some such embodiments, a communication is deleted, or otherwise made irretrievable, if not retrieved before the expiration period lapses. For example, the communication may be stored associated with a particular communication sent timestamp, and the apparatus 200 may delete, or otherwise make irretrievable, the communication upon determining a current timestamp exceeds the communication sent timestamp combined with the expiration period.

The expiration period may be predetermined by the apparatus 200. For example, all communications may be subject to the same expiration period. In some embodiments, the expiration period may be determined based on the generated shadow address. For example, a user may set an expiration period associated with each shadow address. In some such embodiments, the apparatus 200 may retrieve the expiration period associated with a particular shadow address to determine whether a communication has expired, the communication associated with the shadow address as a recipient shadow address. The apparatus 200 may perform one or more expiration checks associated with stored communications at predetermined time intervals (e.g., daily, weekly, monthly, or the like). The apparatus 200 may, alternatively or additionally, perform one or more expiration checks associated with stored communications in response to user-initiated events, such as when a new communication is received from a particular sender shadow address, or when a new communication is received associated with a particular recipient shadow address, such as when the apparatus 200 receives a new communication associated with the particular shadow address. In some embodiments, the apparatus 200 may perform an expiration check based on a count of the stored communications associated with a particular shadow address, for example when the count exceeds a user input or predetermined threshold. Additionally or alternatively, in some embodiments, the apparatus 200 may perform an expiration check in response to user engagement requesting an expiration check (e.g., via an interface component rendered to a client device). Alternatively or additionally still, in some embodiments, the apparatus 200 executes an expiration check in response to receiving a new communication associated with a particular recipient shadow address, or receives a communication retrieval request associated with a particular shadow address.

It should be appreciated that, in some embodiments, communications not retrieved before the expiration period lapses may continue to be stored but irretrievable. In this regard, the expired communications may not be retrieved associated with the communication retrieval request. In other embodiments, communications may be stored indefinitely, or until retrieved.

At block 618, the apparatus 200 includes means, such as shadow transmission management module 214, communications module 208, processor 202, and/or the like, or a combination thereof, for transmitting the communications set to the communication retrieving client device. In some embodiments, the apparatus 200 may generate and/or transmit, in response to the communication retrieval request, a communications retrieval response comprising at least the communications set. In some embodiments, the communications retrieval response comprises additional information associated with the shadow address, communications set, and/or other the like. For example, the communications retrieval response may include data indicating whether communications expired, and/or an expired communication count associated with the shadow address.

The apparatus 200 may cause the communication retrieving client device to perform one or more actions in response to receiving the communications set. In some embodiments, the apparatus 200 causes the communication retrieving client device to render, to an interface associated with the communication retrieving client device, the communications set in response to receiving the transmitted communications set. The communication retrieving client device may render the communications set to enable a user of the device to view each of the communications in the communication set. The communication retrieving client device may, additionally in some embodiments, provide user interface components for managing each communication (e.g., to delete a communication, archive the communication, or the like) and/or responding to each communication (e.g., to respond directly to the sender shadow address, to forward the communication to a new recipient shadow address, or the like). It should be appreciated that the communication retrieving client device may render any number of known user interface components for managing and/or responding to the communications set.

Additionally or alternatively to user-to-user communication, communications may be specially formatted, configured, or otherwise represent command communications for triggering, initiating, and/or otherwise causing one or more actions. In some embodiments, a shadow management system may initiate one or more actions upon receiving a command communication, such as by parsing the command communication and to identify an action commend and transmit one or more signals and/or request to initiate the action. Alternatively or additionally, in some embodiments, the shadow management system may receive a command communication and utilize one or more APIs to initiate one or more corresponding actions. For example, in some embodiments, the shadow management system may communicate with one or more third-party systems, servers, devices, or the like to initiate such actions. In some such embodiments, the shadow management system may transmit one or more requests, data transmissions, or other information via one or more APIs to initiate the action(s).

Command communications may be associated with one or more physical actions, one or more virtual actions, or a combination of physical and virtual actions. In some embodiments, a command communication may be associated with operating a physical device. For example, a command communication may be transmitted to a shadow management system and/or a third-party system to operate a mechanism for opening and/or closing a door. In other examples, an alternative physical mechanism or device may be manipulated, set to a particular state, toggled on-off, or the like. In some embodiments, a command communication may be associated with initiating a virtual and/or electronic process. For example, a command communication may be transmitted to a shadow management system and/or a third-party system to initiate a download or transfer of information, initiate a transfer of electronically managed currency, initiate and/or complete a transaction, initiate and/or complete a login to a service or third-party service, or the like. In some such embodiments, a shadow management system may identify the command communication and parse the command communication to determine an appropriate action to initiate.

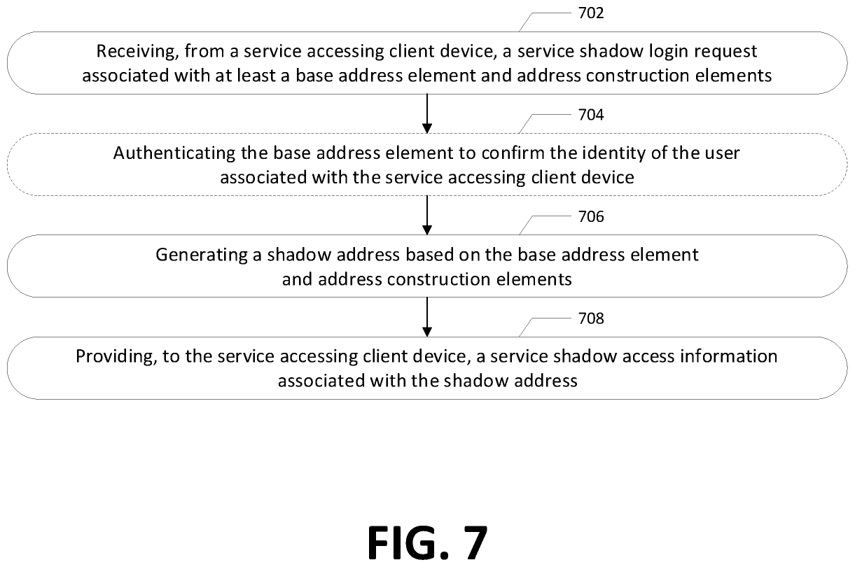

FIG. 7 illustrates an example process for logging into a service associated with a shadow address. Logging into a service associated with a shadow address may embody an example process, or embody a portion of an example process, for managing and utilizing a shadow address, in accordance with an example embodiment of the present disclosure. The example process illustrated may be performed by a shadow management system, for example a shadow management system embodied by apparatus 200. In some embodiments, the apparatus 200 may be configured to communicate with one or more devices, systems, apparatuses, or the like for receiving and/or transmitting the information described with respect to the example process.

At block 702, the apparatus 200 includes means, such as authorization module 210, shadow address management module 212, communications module 208, processor 202, and/or the like, for receiving, from a service accessing client device, a service shadow login request associated with a base address element and address construction element set. The service shadow login request may indicate a user is attempting to log into a user account for a particular service, such as a service associated with the apparatus 200 and/or a third-party service, where the user account is associated with a particular shadow address. For example, the shadow address may have been utilized to register the user account, and the shadow address may function as a username or password associated with the user account.

In some embodiments, the service shadow login request may include the base address element and/or address construction element set. For example, the base address element and/or address constructions elements set may be extracted and/or parsed from the service accessing client device. The service accessing client device may store some or all of the address construction element set, for example stored via authentication software executed on the service accessing client device, which may be retrieved and transmitted for use in generating a corresponding shadow address used for logging into a user account associated with a service.

In some embodiments, the apparatus 200 is configured to identify the base address element associated with the service shadow login request. For example, the apparatus 200 may perform one or more verification processes to identify the base address element. In some such embodiments, the apparatus 200 is configured to perform a header enrichment process to identify and/or authenticate the base address element. For example, in some embodiments, the apparatus 200 may, via an associated a client network comprising a client device, identify a base address element that represents the mobile phone number associated with the service accessing client device.

The service shadow login request may, for example, embody, represent, comprise, or otherwise be associated with a command communication for logging into the service. For example, the service shadow login request may embody a command communication specially formatted to indicate a request to login to a particular service. In this regard, the communication contents may include specific keywords, and/or a specific structure, along with required information such as a username and password, base address, address construction element(s), or the like. In some embodiments, the service shadow login request comprises an indicator that identifies it as a command communication, or specifically identifies it as a service shadow login request.

At optional block 704, the apparatus 200 includes means, such as authorization module 210, shadow address management module 212, communications module 208, input/output module 206, processor 202, and/or the like, or a combination thereof, for identifying or otherwise authenticating the base address element to confirm the identity of the user associated with the service accessing client device. In this regard, the apparatus 200 may ensure that the service accessing client device is associated with the base address element that may be used to generate the shadow address, such as by confirming a user has access to the base address (for example, access via a mobile device or a specific account via the mobile device), such that access to the base address confirms the user's identity. In some embodiments, a base address element is authenticated automatically based on the verification process utilized to identify the base address element. For example, a base address element may be automatically authenticated when utilizing a header enrichment process to identify the base address element. In other embodiments, the authentication process may utilize a standard login process, for example by authenticating a username and password combination. In some such embodiments, the username, password, or a combination thereof, may form the base address, or other account information associated with the username and password, such as an account identifier, may form the base address. Alternatively or additionally, some embodiments may employ a non-DAA authentication process, such as an OAuth authentication process, a remote authentication dial-in user service process, a login authentication process or other authentication process.

In other embodiments, the base address element may be received associated with, signed with, or including, authentication information. The authentication information may identify that the base address element has been authenticated as associated with the client device by an authentication server. For example, in some embodiments, the base address element may be signed by a signing authority, and the signed base address element may be provided by the client device, such as included in, or along with, the service shadow login request. The base address element may be authenticated or verified using one or more address construction elements provided in the address construction element set (e.g., a public key associated with the client device or the shadow address). In other embodiments, the apparatus 200 may be configured to perform one or more login processes to authenticate the base address element.

At block 706, the apparatus 200 includes means, such as shadow address management module 212, processor 202, and/or the like, or a combination thereof, for generating a shadow address based on the base address element and the address construction element set. The generated shadow address may, in this regard, be associated with the service accessing client device. The shadow address may be generated based on a combined address element that includes a combination of the base address element and a combination of some or all of the address construction elements. For example, in some embodiments, the apparatus 200 may generate a combined address construction element based on one or more of the address construction elements. For example, each address construction element may be a string type, such that the combined address construction element may be formed by concatenating some or all of the address construction elements in the address construction element set. In some embodiments, each address construction element may be separated by a reserved separator character. In some embodiments, the combined address construction element may represent the concatenation of all address construction elements, and any separator characters if required. In other embodiments, it should be appreciated that one or more other algorithms may be utilized to generate a combined address construction element. For example, in some embodiments the address construction element set may be applied to one or more mathematical transformation algorithms and/or hash functions.

The apparatus 200 may generate a combined address element based on the base address element and the combined address construction element. For example, in some embodiments, the combined address element may be generated by concatenating the base address element with the combined address construction element. In other embodiments, the base address element and combined address construction element may be applied to one or more functions, algorithms, or the like to generate the resulting combined address element.

The apparatus 200 may generate the shadow address using one or more one-way transformations and/or hash functions. In some embodiments, the base address element and the address construction element set may be applied to a hash function to generate the shadow address. For example, in some embodiments, the shadow address is generated by applying the combined address element to one or more hash functions. In other embodiments, the hash function may generate the shadow address based on the base address element and the combined address construction element, or the base address element and the address construction element set. In some embodiments, the apparatus 200 may be configured to utilize a predetermined hash function. In other embodiments, the apparatus 200 may determine the hash function to utilize based on one or more parameters, for example the hash function may be determined based on the communication type, the sender shadow address, the recipient shadow address, or one or more values of the address construction elements.

In some embodiments, the shadow address is generated by applying the one-way transformation, such as the hash function, once. In other embodiments, multiple iterations of the one-way transformation and/or hash function may be utilized. For example, the hashed elements may be hashed twice or more in some embodiments, and/or utilize additional information (e.g., different address construction elements) for each iteration of hashing. In some embodiments, multiple one-way transformations and/or hash functions may be utilized to perform multiple iterations of transformations or hashing. For example, in some embodiments, a first hash function may be utilized, then a second hash function. Alternatively, for example, a first hash function may be utilized twice, or a first hash function may be utilized twice, then a second hash function utilized once or more.

The one-way transformation(s), for example the hash function(s), may be configured to generate a shadow address in a predetermined format. In some embodiments, the format of the shadow address may be based on the base address represented by the base address element. For example, in embodiments where the base address is a mobile phone number, the shadow address may be generated in a predetermined phone number format (e.g., 7 digits or 10 digits). In embodiments where the base address is an email, the shadow address may be generated in a predetermined alphanumeric format having a maximum length in email format (e.g., having a maximum amount of characters including an @ separator). In other embodiments, a base address may embody another identifier, username, login, or the like, and the corresponding shadow address may be generated in any of a myriad of alphanumeric, numeric, or other formats.

At block 708, the apparatus 200 includes means, such as authorization module 210, shadow address management module 212, communications module 208, processor 202, and/or the like, or a combination thereof, for providing, to the service accessing client device, service shadow access information associated with the shadow address. In some embodiments, the apparatus 200 may provide the service shadow access information to the service accessing client device to cause the service accessing client device to access the service using the service shadow access information. For example, the apparatus 200 may cause the service accessing client device to provide the service shadow access information to a service device associated with the service to be accessed, such that the service device authenticates or otherwise verifies the service shadow access information to enable login via the service accessing client device.

In other embodiments, the apparatus 200 may perform and/or complete a login process associated with the service on behalf of the service accessing client device. For example, the apparatus 200 may communicate with one or more service devices associated with the service to provide the shadow address and/or additional information to facilitate verification and/or authorization. The service accessing client device may receive, in response from the service device(s), service shadow access information (or a portion thereof) for future accessing of the service via the service device. In other embodiments where the service is associated with, or otherwise managed by, the apparatus 200 or a sub-system thereof may generate and/or retrieve the service shadow access information. For example, in some embodiments the service shadow access information may be generated and/or retrieved based on the generated shadow address.

In some embodiments, the service shadow access information may be embodied by the shadow address. In other embodiments, the service shadow access information may be embodied by user credentials (e.g., a username, password, and/or other identification information, or a combination thereof) associated with the shadow address. In other embodiments still, the service shadow access information may be embodied by an authentication token, or encrypted authentication information that may be used for verification and/or authentication by the service device associated with the service. In some such embodiments, the service device may generate and provide service shadow access information, for example in response to receiving the shadow address, and/or additional information associated with the shadow address or service, from the apparatus 200.

The service shadow access information, in some embodiments, is provided to the service accessing client device as a communication. The communication may, for example, be a login communication generated and/or transmitted by the apparatus 200. The communication may be configured, structured/formatted, and/or otherwise indicate that the communication embodies a login communication. The apparatus 200 may provide the login communication comprising the service shadow access information to the service accessing client device to cause the service accessing client device to continue and/or complete a login or user confirmation process associated with a service.

### Example Operations Performed by Enhanced Client Apparatus

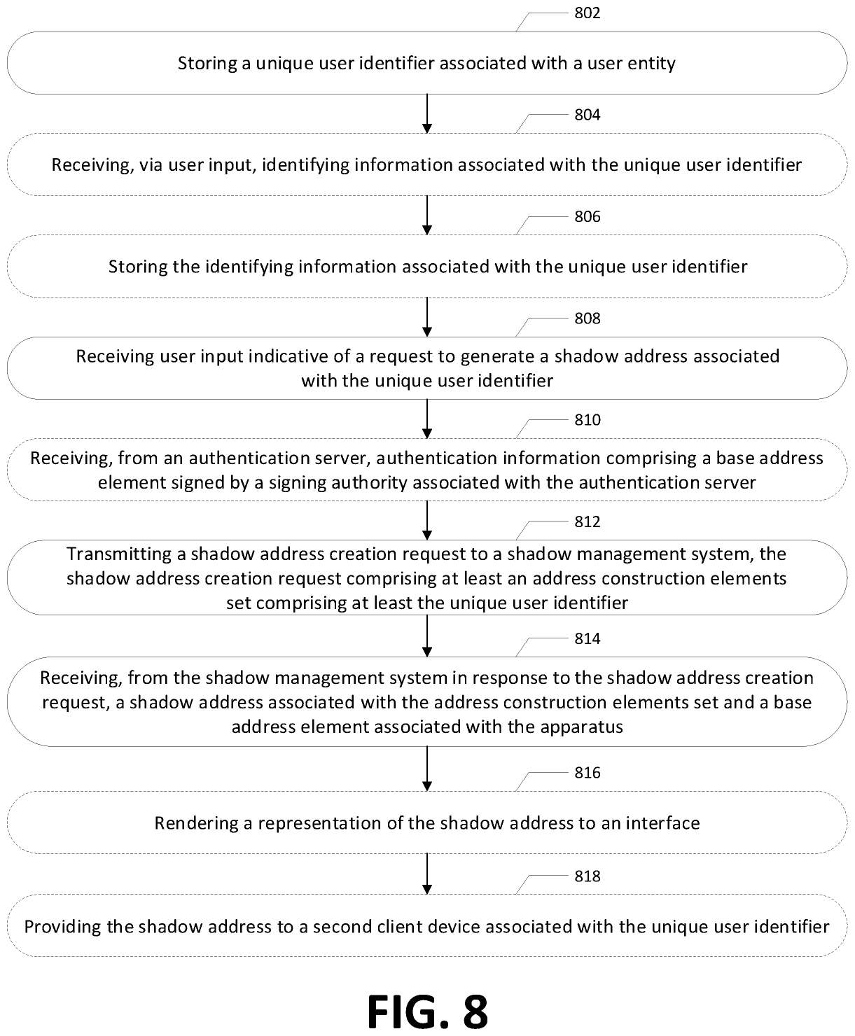

FIG. 8 illustrates an example process for creating, managing, and utilizing a shadow address, in accordance with an example embodiment of the present disclosure. The example process illustrated may be performed by a client device, for example a client device embodied by apparatus 300. In some embodiments, the apparatus 300 may be configured to communicate with one or more devices, systems, apparatuses, or the like, for receiving and/or transmitting the information described below with respect to the example process.

At block 802, the apparatus 300 includes means, such as client shadow address management module 310, input/output module 306, memory 304, processor 302, and/or the like, or a combination thereof, for storing a unique user identifier associated with a user entity. In some embodiments, the unique user identifier may be received from a user associated with the apparatus 300, for example via user input. In some examples, the unique user identifier may be used to identify a particular contact stored via contact management software executed on the apparatus 300. For example, the unique user identifier may be a contact name, description, or label associated with the user entity and inputted by a user via the apparatus 300. In other examples, the unique user identifier may be a unique numerical and/or alphanumeric identifier (e.g., a string identifier) generated and assigned associated with the contact inputted into the contacts management software.

The unique user identifier may be stored via the contacts management software executed via the apparatus 300. The unique user identifier may be stored in one or more databases, repositories, or the like, such that it is retrievable for transmission to a shadow management system. In some embodiments, the apparatus 300 may be configured to render, via an interface, a user interface component for generating a shadow address associated with the unique user identifier. In this regard, the apparatus 300 may enable generation of a shadow address via the shadow management system, for example by generating and/or transmitting a shadow address generation request including an address construction element set comprising at least the unique user identifier for use in generating the corresponding shadow address.

At optional block 804, the apparatus 300 includes means, such as client shadow address management module 310, memory 304, processor 302, and/or the like, or a combination thereof, for receiving, via user input, identifying information associated with the unique user identifier. In some embodiments, the identifying information may, for example, include a name, a photo, a category, a label, a description, a shadow address, a base address, or other notes associated with the user entity. In some embodiments, some of the identifying information may be included in an address construction element set for generating a corresponding shadow address. It should be appreciated that, in other embodiments, all or none of the identifying information may be included.

At optional block 806, the apparatus 300 includes means, such as client shadow address management module 310, input/output module 306, memory 304, processor 302, and/or the like, or a combination thereof, for storing the identifying information associated with the unique user identifier. In some embodiments, the identifying information may be stored via contacts management software executed via the apparatus 300. For example, in some embodiments, the contacts management software embodies an address book managed via the apparatus 300. The address book may be used to create and manage contacts, and associated information for identifying and/or communicating with each contact identified by the unique user identifier. The apparatus 300 may store the identifying information associated with a corresponding unique user identifier in one or more databases, repositories, storages, or the like. In this regard, the identifying information may be retrieved along with and/or utilizing the unique user identifier.

At block 808, the apparatus 300 includes means, such as client shadow address management module 310, input/output module 306, processor 302, and/or the like, or a combination thereof, for receiving user input indicative of a request to generate a shadow address associated with the unique user identifier. In some embodiments, the apparatus 300 may be configured to render, to an interface, a user interface component indicating a desire to generate a shadow address associated with the unique user identifier. For example contacts management software, such as an address book, may include a button rendered associated with a stored contact associated with the unique user identifier.

In some embodiments, the apparatus 300 may generate and/or render an interface including each stored unique user identifier. The user of the apparatus 300 may, via user engagement, select a unique user identifiers for which a shadow address should be generated. It should be appreciated that in other embodiments, the apparatus 300 may render an interface enabling a user to input a unique user identifier and/or additional identifying information for generating a corresponding shadow address without selecting from stored unique user identifier(s). In some such embodiments, the apparatus 300 may store the user entered unique user identifier and/or additional identifying information in a database, repository, blockchain, or the like. For example, the unique user identifier and/or identifying information may be stored as a contact in contacts management software, such as an address book software application executed via the apparatus 300 for managing such information.

In some alternative embodiments, the apparatus 300 may not store the unique identifier or identifying information. In some such embodiments, to access and/or utilize a shadow address, the client device may be configured to provide one or more interfaces for the user to input, for example via user engagement, the unique user identifier and/or other identifying information used as an address construction set to generate the shadow address. In some such embodiments, the user may be required to manually track the base address elements and/or address construction element set utilized to generate a shadow address. For example, a user may utilize easy to remember strings as address construction elements to be provided for accessing a particular shadow address utilized for a particular purpose (e.g., “public” for a public address, “bob from work” for communications with particular user Bob). In some embodiments, such as where a base address element is automatically identified and/or authenticated by a shadow management system, the apparatus 300 may be configured to provide inputs only for an address construction element set.

At optional block 810, the apparatus 300 includes means, such as client shadow address management module 310, communications module 308, processor 302, and/or the like, or a combination thereof, for receiving, from an authentication server, authentication information comprising a base address element signed by a signing authority associated with the authentication server. In some embodiments, the authentication information may be received in response to an authentication request transmitted from the apparatus 300 to the authentication server. The authentication request may represent a request for the authentication via one or more verification processes performed by the authentication server. For example, the authentication server may be configured to perform one or more verification processes, including but not limited to, a DAA process such as a header enrichment process, an OAuth process, a remote authentication dial-in user service process, or other verification process. The authentication information may be received via the verification process, retrieved upon successful completion of the verification process, and/or generated upon successful completion of the verification process for authenticating the identity of the apparatus 300. In some embodiments, the authentication server may operate as a signing authority for signing the authentication information. In other embodiments, the authentication server may be communicable with an authentication server, for example via one or more networks, for signing the base address element.

In some embodiments, the authentication information may further include, or be received associated with, a public key used for authenticating the signature associated with the signed base address element. The public key may be associated with the authentication server and/or signing authority. Additional keys or information may be provided to enable a system to confirm the authentication information is associated with the apparatus 300.

At block 812, the apparatus 300 includes means, such as client shadow address management module 310, communications module 308, processor 302, and/or the like, or a combination thereof, for transmitting a shadow address creation request to a shadow management system, the shadow address creation request comprising at least an address construction element set comprising at least the unique user identifier. In some embodiments, the apparatus 300 transmits the shadow address creation request via one or more networks. In some embodiments, the apparatus 300 transmits the shadow address creation request via a carrier network comprising at least one carrier device configured to perform a DAA process, for example a header enrichment process.

The shadow address creation request may include, or otherwise be associated with, a base address element. For example, in some embodiments, the apparatus 300 may retrieve and/or identify a base address element and include it in the shadow address creation request. The base address element may, for example, be a mobile phone number, email address, login, or the like accessible to or otherwise associated with the apparatus 300. In some embodiments, the base address element is injected into the shadow address creation request via a header enrichment process in response to transmission by the apparatus 300 to, or via, a carrier device associated with a carrier network. In such embodiments, the shadow management system may receive the injected base header element via the client device indirectly.

In some embodiments, for example where authentication information was received from an authentication server, the apparatus 300 may further include the authentication information. In some such embodiments, the authentication information may include or otherwise be associated with a base address element, such that the authentication information may be used to verify the apparatus 300 is associated with the base address element. The base address element and address construction element set may, in some such embodiments, be utilized to generate a shadow address after confirming the authentication information.

At block 814, the apparatus 300 includes means, such as client shadow address management module 310, communications module 308, processor 302, and/or the like, or a combination thereof, for receiving, from the shadow management system in response to the shadow address creation request, a shadow address associated with the address construction element set and a base address element associated with the apparatus. The shadow address may be received as part of a shadow address generation response. The shadow address generation response may additionally include metadata or information associated with the shadow address, or one or more representations of the shadow address. For example, the shadow address generation response may include information for rendering one or more a text representation, encoded representation, and/or scannable representation(s) of the shadow address.

The shadow address, and/or additional or associated information, may be received via the same network utilized to transmit the shadow address generation request. For example, in some embodiments the shadow address generation request may be transmitted via a carrier network, and the shadow address may be received via the same carrier network. In other embodiments, the shadow address may be received via a second network. For example, the shadow address generation request may be transmitted via a Wi-Fi network, and the shadow address may be received via a carrier network, or the reverse.

In some embodiments, the shadow address or associated information may be stored upon receiving the shadow address. For example, in some embodiments, the apparatus 300 may store the shadow address received via the shadow management system. In other embodiments, the address construction elements, and in some embodiments the base address element, may be stored for use in regenerating the shadow address via the shadow management system at a later time. Alternatively, one or more representations of the shadow address, or associated information for rendering a corresponding representation, may be stored. In such embodiments, the stored information may be retrieved to generate and/or render the representation at a later point in time. For example, the representation may be used to share the shadow address with another user associated with another client device (such as a user associated with the unique user identifier). In other embodiments where the address construction element set is already stored, for example as a unique user identifier and/or identifying information stored as a contact in contacts management software, only some or no information may be stored. In some embodiments, a shadow address, signed by and/or associated with information for validating the shadow address is associated with the client device, may be stored on or accessible to the client device via a session management tool. For example, the shadow address may be stored in an electronically managed cookie maintained by or accessible to the client device. In this regard, the shadow address may be retrieved for subsequent utilization during a particular session without requiring re-authentication of the user of the client device. Additionally or alternatively, a shadow address may be stored in a session object for the duration of a particular session, or associated with a particular timeout interval or timestamp.

At optional block 816, the apparatus 300 includes means, such as client shadow address management module 310, input/output module 306, processor 302, and/or the like, or a combination thereof, for rendering a representation of the shadow address to an interface. In some embodiments, the representation may be a text representation. The text representation may be human-readable or encoded, for example as a binary string. Additionally or alternatively, the representation may be presented as a scannable representation. For example, the shadow address may be presented as a QR code, bar code, or other scannable representation that utilizes detecting and/or decoding via an electronic device. In some embodiments, the scannable representation may represent an encoded text representation, such that a string retrieved from scanning the scannable representation must be further decoded to determine the shadow address.

In some embodiments, the apparatus 300 includes means for generating the representation of the shadow address based on the received shadow address. For example, the apparatus 300 may generate one or more text, image, scannable, and/or encoded representations of the shadow address, which may be rendered to an interface or provided to another client device. For example, in some embodiments, the apparatus 300 may be configured with one or more algorithms for generating a QR code, bar code, and/or another scannable representation based on the retrieved shadow address. Additionally or alternatively, in some embodiments, the apparatus 300 may be configured with one or more algorithms for generating a binary, or other encoded representation based on the retrieved shadow address.

In some embodiments, the apparatus 300 includes means to receive the representation of the shadow address. For example, the representation of the shadow address may be generated by a shadow management system along with the shadow address. The apparatus 300 may receive the representation(s) of the shadow address as part of a shadow address creation response. The representation(s) of the shadow address may be parsed and/or extracted from the shadow address creation response for rendering to an interface.

At block 818, the apparatus 300 includes means, such as client shadow address management module 310, communications module 308, input/output module 306, processor 302, and/or the like, or a combination thereof, for providing the shadow address to a second client device associated with the unique user identifier. The apparatus 300 may cause the second client device to store the shadow address. For example, the apparatus 300 may provide the shadow address for the second client device to use to communicate with the apparatus 300, and may provide an identifier and/or information for the second client device to use to store the shadow address. The second client device may store the shadow address and/or any other additionally provided information, for example in a database, repository, blockchain storage, or the like. In some embodiments, the second client device may be stored as a contact via contacts management software executed on the second client device.

In some embodiments, the shadow address may be shared with the second client device electronically, for example via one or more transmissions to the second client device. In some embodiments, the apparatus 300 may transmit the shadow address to the second client device via one or more communications to a previously received second shadow address associated with the second client device. The second shadow address may be stored associated with a unique user identifier, for example associated with a contact stored, or a new contact to be generated and stored, associated with contacts management software executed via the apparatus 300. Additionally or alternatively, in some embodiments, the shadow address may be shared through one or more known messaging methods, for example via email, SMS messaging, social media messaging, or the like.

Additionally or alternatively, in some embodiments, the shadow address may be provided via a rendered representation of the shadow address, for example rendered to an interface at an earlier block. The second client device may be configured to receive user input embodying the shadow address based on the rendered representation of the shadow address. For example, the user may enter a human-readable text representation, or an encoded representation for decoding by the second client device. Alternatively, the user of the second client device may utilize the second client device to detect and/or decode a scannable representation. For example, the second client device may be a mobile device. In some such embodiments, the user of the second client device may utilize a camera associated with the second client device, and associated software, to detect and decode the scannable representation to determine the shadow address. The shadow address may then be stored, for example to utilize in communicating with the apparatus 300.

### CONCLUSION

In some embodiments, some of the operations described above with respect to the flow charts and/or data flows may be modified or further amplified. Furthermore, in some embodiments, additional optional operations may be included. Modifications, amplifications, or additions to the operations above may be performed in any combination.

Having the benefit of the teachings presented in the foregoing description and the associated drawings, many modifications and other embodiments of the disclosure set forth herein will come to mind to one skilled in the art to which this disclosure pertains. Therefore, it is to be understood that embodiments of the disclosure are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only, and not for purposes of limitation.

1. An apparatus for managing communications via shadow addresses, the apparatus comprising at least one processor, the at least one memory having computer-coded instructions therein, the computer-coded instructions configured to, in execution with the processor, cause the apparatus to:
receive, from a client device, an address construction element set;
identify a base address element associated with the client device; and
generate a shadow address based on the base address element and the address construction element set, wherein to generate the shadow address the apparatus is configured to:
apply the base address element and the address construction element set to at least one one-way transformation function.

2. The apparatus of claim 1, wherein to identify the base address element associated with the client device, the apparatus is configured to:
identify the base address element using a header enrichment process performed via a carrier network.

3. The apparatus of claim 1, further configured to:
authenticate the base address element using an authentication process to confirm the identity of the user associated with the client device.

4. The apparatus of claim 1, further configured to:
receive, from a communication transmitting client device, at least one communication transmission signals, the at least one communication transmission signals associated with at least one communication associated with the shadow address; and
store the at least one communication associated with the shadow address.

5. The apparatus of claim 4, wherein to store the at least one communication associated with the shadow address, the apparatus is configured to store at least a portion of the at least one communication to a communication storage blockchain based on the shadow address.

6. The apparatus of claim 1, wherein the client device comprises a first client device, the apparatus further configured to:
receive, from a retrieving client device, a communication retrieval request associated with the base address element and the address construction element set;
authenticate the base address element to confirm the identity of the user associated with the retrieving client device;
generate the shadow address based on the base address element and the address construction element set;
retrieve a communications set based on the shadow address, the communications set comprising the at least one communication associated with the shadow address; and
transmit the communications set to the retrieving client device.

7. The apparatus of claim 6, wherein each communication of the communications set comprises the shadow address in a recipient shadow address field.

8. The apparatus of claim 1, wherein the shadow address is associated with a shadow address restriction settings set comprising a verified sender shadow address set.

9. The apparatus of claim 1, wherein the shadow address is associated with a shadow address restriction settings set comprising a communication permissions set.

10. The apparatus of claim 1, wherein the base address comprises an electronic representation of a telephone number or an electronic representation of an email address.

11. The apparatus of claim 1, wherein to receive the address construction element set, the apparatus is configured to:
receive, from the client device, a shadow address generation request comprising the address construction element set and the base address element,
wherein, to identify the base address element, the apparatus is configured to parse the shadow address generation request to extract the base address element.

12. The apparatus of claim 1, further configured to:
receive, from a service accessing client device, a service shadow login request comprising at least the base address element and the address construction elements;
authenticate the base address element to confirm the identity of the user associated with the service accessing client device;
generate the shadow address based on the base address element the address construction element set; and
provide, to the service accessing client device, service shadow access information associated with the shadow address, the service shadow access information configured to enable access to a service.

13. A computer-implemented method for managing communications via shadow addresses, the method comprising:
receiving, from a client device, an address construction element set;
identifying a base address element associated with the client device; and
generating a shadow address based on the base address element and the address construction element set, by:
applying the base address element and the address construction element set to at least one one-way transformation function.

14. (canceled)

15. The method of claim 13, further comprising:
authenticating the base address element using an authentication process to confirm the identity of the user associated with the client device.

16. The method of claim 13, further comprising:
receiving, from a communication transmitting client device, at least one communication transmission signals, the at least one communication transmission signals associated with at least one communication associated with the shadow address; and
storing the at least one communication associated with the shadow address.

17. The method of claim 16, wherein storing the at least one communication associated with the shadow address comprises storing at least a portion of the at least one communication to a communication storage blockchain based on the shadow address.

18. The method of claim 13, wherein the client device comprises a first client device, the method further comprising:
receiving, from a retrieving client device, a communication retrieval request associated with the base address element and the address construction element set;
authenticating the base address element to confirm the identity of the user associated with the retrieving client device;
generating the shadow address based on the base address element and the address construction element set;
retrieving a communications set based on the shadow address, the communications set comprising the at least one communication associated with the shadow address; and
transmitting the communications set to the retrieving client device.

19-22. (canceled)

23. The method of claim 13, wherein receiving the address construction element set comprises:
receiving, from the client device, a shadow address generation request comprising the address construction element set and the base address element,
wherein identifying the base address element comprises parsing the shadow address generation request to extract the base address element.

24. The method of claim 13, further comprising:
receiving, from a service accessing client device, a service shadow login request comprising at least the base address element and the address construction elements;
authenticating the base address element to confirm the identity of the user associated with the service accessing client device;
generating the shadow address based on the base address element the address construction element set; and
providing, to the service accessing client device, service shadow access information associated with the shadow address, the service shadow access information configured to enable access to a service.

25. A computer program product for managing communications via shadow addresses, the computer program product comprising a non-transitory computer readable storage medium having computer program instructions stored therein, the computer program instructions, when executed by a processor, configured for:
receiving, from a client device, an address construction element set;
identifying a base address element associated with the client device; and
generating a shadow address based on the base address element and the address construction element set, by:
applying the base address element and the address construction element set to at least one one-way transformation function.

26-60. (canceled)
